(19) United States
(12) Patent Application Publication
(10) Pub. No.: US 2019/0102826 A1
(43) Pub. Date: Apr. 4, 2019

(54) Retail Support Methods

(71) Applicants: Michia Rohrssen, San Francisco, CA (US); Martin Hu, San Francisco, CA (US); Eric Davis, San Francisco, CA (US)

(72) Inventors: Michia Rohrssen, San Francisco, CA (US); Martin Hu, San Francisco, CA (US); Eric Davis, San Francisco, CA (US)

(21) Appl. No.: 15/720,327

(22) Filed: Sep. 29, 2017

(51) Int. Cl. G06Q 30/06; G06Q 30/02; G06Q 40/02; G06Q 40/08; G06F 3/0481; G06F 3/0482

(52) U.S. Cl. CPC G06Q 30/0641; G06Q 30/0283; G06F 3/0482; G06Q 40/08; G06F 3/04817; G06Q 40/025

(57) ABSTRACT

Retail support methods are described. An example retail support method includes the steps: obtaining attributes associated with a plurality of items; organizing the attributes such that one or more of the attributes is grouped within a class having a class identifier; providing an interface that displays one or more of the class identifiers and provides a user interface element for selecting one or more of the class identifiers; receiving data relating to a selection of the class identifiers; providing another interface that displays one or more of the items and provides a second user interface element for creating a selected subset; receiving data relating to the selected subset; providing another interface that displays the selected subset, the attributes associated with the selected subset, and provides a third user interface element to submit a request to evaluate one or more items; and making the one or more items available for evaluation.

### FIELD

The disclosure relates generally to the field of retail support. More particularly, the disclosure relates to retail support methods useful for purchasing an item.

### BACKGROUND

When purchasing an item, a consumer generally researches various sources to become familiar with the type of item they intend on purchasing and the various qualities and characteristics associated with the item. When the consumer is ready to purchase the item he/she can either purchase the item online or in person. When purchased online, current systems and methods provide difficult to understand processes for completing transactions, especially in cases in which the item is expensive, such as a vehicle. When purchased in person, the consumer travels to the location of the item and determines which type of item and accommodations are desired by viewing multiple items and/or speaking with a salesperson. Subsequently, the consumer discusses the purchase of the item with a salesperson and, once a price has been negotiated, can either purchase the item or be redirected to a financial advisor to obtain a line of credit. Both approaches can be time consuming and complex for the consumer.

From the perspective of the person selling the item, the process is similarly complex. For example, with respect to online sales, many leads depend upon a consumer providing personal details such that the person selling the item can provide a final sale price to the consumer. This model has several drawbacks. For example, it may not be desirous for the person selling the item to provide a final sale price to the consumer without a face to face meeting to discuss the item. With respect to completing a sale with a consumer that has traveled to the location of the item, the person selling the item generally spends a large amount of time with the consumer to determine the exact item desired and whether the consumer even qualifies for financing to purchase the item. This decreases the face to face time the person selling the item can spend with other consumers and may result in lower productivity.

Accordingly, a need exists for new and useful approaches to providing retail support.

### SUMMARY OF SELECTED EXAMPLE EMBODIMENTS

Various retail support methods are described herein.

An example retail support method comprises the steps of: obtaining one or more attributes associated with each item of a plurality of items, each attribute based on a specific quality of each item of the plurality of items; organizing the one or more attributes such that one or more of the attributes of each item of the plurality of items is grouped within a class having a class identifier; providing a first interactive user interface that displays to a user one or more of the class identifiers and provides a first user interface element for selecting one or more of the class identifiers; receiving data relating to a selection made by a user of one or more of the one or more class identifiers; providing a second interactive user interface that displays to the user one or more of the items based on the received data relating to the selection of one or more of the one or more class identifiers and provides a second user interface element for creating a selected subset that comprises one or more items of the one or more of the items; receiving data relating to the selected subset of the one or more items; and providing a third interactive user interface that displays to the user the selected subset of the one or more items, the attributes associated with the selected subset of the one or items, and provides a third user interface element for submitting a request to evaluate one or more items of the selected subset of the one or more items; and making the one or more items of the selected subset of the one or more items available to the user for evaluation.

Another example retail support method comprises the steps of: obtaining one or more attributes associated with each vehicle of a plurality of vehicles, each attribute based on a specific quality of each vehicle of the plurality of vehicles; organizing the one or more attributes such that one or more of the attributes of each vehicle of the plurality of vehicles is grouped within a class having a class identifier; providing a first interactive user interface that displays to a user one or more of the class identifiers and provides a first user interface element for selecting one or more of the class identifiers; receiving data relating to a selection made by the user of one or more of the one or more class identifiers; providing a second interactive user interface that displays to the user one or more of the vehicles based on the received data relating to the selection of one or more of the one or more class identifiers and provides a second user interface element for creating a selected subset that comprises one or more vehicles of the one or more of the vehicles; receiving data relating to the selected subset; providing a third interactive user interface that displays to the user the selected subset of the one or more vehicles, the attributes associated with the selected subset of the one or more vehicles, and provides a third user interface element for submitting a request to evaluate one or more vehicles of the selected subset of the one or more vehicles; making the one or more vehicles of the selected subset of the one or more vehicles available to the user for evaluation; and providing a fourth user interface element to request assistance from a third party such that a notification is sent to a remote device controlled by the third party when data relating to a request for assistance from the third party is received.

Another example retail support method comprises the steps of: obtaining one or more attributes associated with each vehicle of a plurality of vehicles, each attribute based on a specific quality of each vehicle of the plurality of vehicles; organizing the one or more attributes such that one or more of the attributes of each vehicle of the plurality of vehicles is grouped within a class having a class identifier; providing a first interactive user interface that displays to the user one or more of the class identifiers and provides a first user interface element for selecting one or more of the class identifiers; receiving data relating to a selection made by the user of one or more of the one or more class identifiers; providing a second interactive user interface that displays to the user one or more of the vehicles based on the received data relating to the selection of one or more of the one or more class identifiers and provides a second user interface element for creating a selected subset that comprises one or more vehicles of the one or more of the vehicles; receiving data relating to the selected subset of the one or more vehicles; providing a third interactive user interface that displays to the user the selected subset of the one or more vehicles, the attributes associated with the selected subset of the one or more vehicles, and provides a third user interface element submitting a request to evaluate one or more vehicles of the selected subset of the one or more vehicles; making the one or more vehicles of the selected subset of the one or more vehicles available to the user for evaluation; receiving data relating to the request to evaluate one or more vehicles of the selected subset of the one or more vehicles; receiving additional data relating to the user based upon the receipt of data relating to the request to evaluate one or more vehicles of the selected subset of the one or more vehicles; providing a fourth user interface element to request assistance from a third party such that a notification is sent to a remote device controlled by the third party when data relating to a request for assistance from the third party is received; receiving data relating to a request for assistance from the third party; and sending the data relating to the request for assistance from the third party, data relating to the user, data relating to the selection of one or more of the one or more class identifiers, and data relating to the selected vehicle to the remote device controlled by the third party.

Additional understanding of the example retail support methods can be obtained by review of the detailed description, below, and the appended drawings.

### BRIEF DESCRIPTION OF THE DRAWINGS

FIG. 1 is a schematic illustration of an example retail support method.

FIG. 2 is an illustration of an example network that can be used to implement the retail support methods described herein.

FIGS. 3 through 5 are screen renderings of example user interfaces that can be displayed to a user.

FIG. 6 is a schematic illustration of another example retail support method.

FIGS. 7 through 17 are screen renderings of example user interfaces that can be displayed to a user.

FIGS. 18 and 19 are schematic illustrations of another example retail support method.

FIGS. 20 through 37 are screen renderings of example user interfaces that can be displayed to a user.

FIG. 38 is a schematic illustration of another example retail support method.

### DETAILED DESCRIPTION

The following detailed description and the appended drawings describe and illustrate various example embodiments of retail support methods. The description and illustration of these examples are provided to enable one skilled in the art to practice a retail support method. They are not intended to limit the scope of the claims in any manner.

As used herein, the term “user” means any person completing, or assisting a person with completing, one or more of the retail support methods, steps, alternative steps, and/or optional steps described herein. Examples of users considered suitable to complete one or more of the retail support methods, steps, alternative steps, and/or optional steps described herein include any person using a user device, an individual interested in purchasing an item, such as a customer, a person affiliated with the sale of an item, such as a salesperson, a manager, an owner, and any other person considered suitable for a particular embodiment.

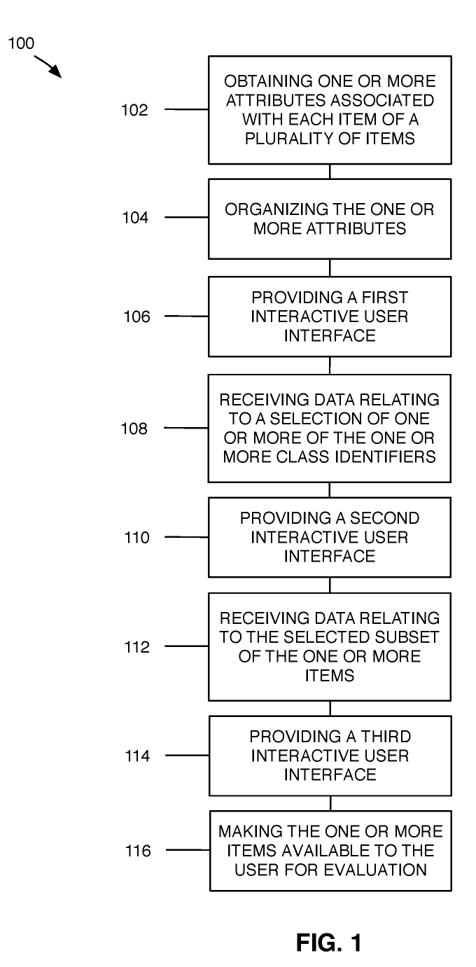

Various retail support methods are described herein. While the methods described herein are shown and described as a series of acts, it is to be understood and appreciated that the methods are not limited by the order of acts as some acts may, in accordance with these methods, occur in the order shown and described, in different orders, and/or concurrently with other acts described herein. FIGS. 1, 6, 18, 19, and 38 each illustrate a schematic representation of an example retail support method. Each method is illustrated as a collection of blocks in a logical flow graph, which represents a sequence of operations that can be implemented in hardware, software, or a combination of hardware and software. In the context of software, the blocks can represent computer-executable instructions that, when executed by one or more processors, perform the recited operations. Generally, computer-executable instructions include routines, programs, objects, components, data structures, modules, and the like that perform particular functions or implement particular abstract data types. As indicated above, the order in which the operations are described is not intended to be construed as a limitation, and any number of the described blocks can be combined in any order and/or in parallel to implement a retail support method.

FIG. 1 is a schematic illustration of a retail support method 100.

A step 102 comprises obtaining one or more attributes associated with each item of a plurality of items, each attribute based on a specific quality of each item of the plurality of items. Another step 104 comprises organizing the one or more attributes such that one or more of the attributes of each item of the plurality of items is grouped within a class having a class identifier. Another step 106 comprises providing a first interactive user interface that displays to a user one or more of the class identifiers and provides a first user interface element for selecting one or more of the class identifiers. Another step 108 comprises receiving data relating to a selection made by the user of one or more of the one or more class identifiers. Another step 110 comprises providing a second interactive user interface that displays to the user one or more of the items based on the received data relating to the selection of one or more of the one or more class identifiers and provides a second user interface element for creating a selected subset that comprises one or more items of the one or more of the items. Another step 112 comprises receiving data relating to the selected subset of the one or more items. Another step 114 comprises providing a third interactive user interface that displays to the user the selected subset of the one or more items, the attributes associated with the selected subset of the one or items, and provides a third user interface element for submitting a request to evaluate one or more items of the selected subset of the one or more items. Another step 116 comprises making the one or more items of the selected subset of the one or more items available to the user for evaluation.

The steps, alternative steps, and optional steps described herein can be completed using any suitable technique or method and selection of a suitable technique or method to complete the steps, alternative steps, and optional steps described herein can be based on various considerations, including the type of retail support intended to be provided to a user. Example techniques and methods considered suitable to complete the steps, alternative steps, and/or optional steps described herein include using a phone service, using a computer, using one or more electronic devices, using a client-server computer system, using a client-server computer system in which at least one of the client or server is connected to a network (e.g., the Internet), using a web application, mobile application, using a computer-readable medium, an application provided by a third party, an Application Program Interface (API), a software development kit (SDK), combinations of the techniques and methods described herein, and/or any other technique or method considered suitable for a particular embodiment. As described herein, embodiments of the retail support methods can be implemented in suitable computer-executable instructions that may reside on a computer readable medium, hardware circuitry, or any combination of suitable components. For example, the computer-executable instructions may be stored as software code components or modules on one or more computer readable mediums. The computer-executable instructions may include lines of any suitable code, such as C++, Java, HTML, or any other programming or scripting code.

The steps, alternative steps, and/or optional steps described herein may be implemented on one computer or shared, distributed, among two or more computers. Communication between computers implementing the steps, alternative steps, and/or optional steps described herein can be accomplished using any electronic, optical, radio frequency signal, or other suitable techniques or methods of communication. A computer, such as those described herein, can include a central processing unit (“CPU”), at least one read-only memory (“ROM”), at least one random access memory (“RAM”), at least one hard drive (“HD”), a server, and/or one or more input/output (“I/O”) device(s), among other devices and/or components. The I/O devices can include a keyboard, monitor, printer, electronic pointing device (such as a mouse, trackball, stylist, etc.), or any other suitable I/O device. In various embodiments, the computer has access to at least one database or external source that may include a database over a network. Each of ROM, RAM, and HD are computer-readable mediums for storing computer instructions executable by the CPU. While various types of computer-readable mediums have been described, any suitable computer-readable medium can be used to store data and/or instructions relating to completing the steps, alternative steps, and optional steps described herein. Examples of computer-readable mediums considered suitable to store data and/or instructions relating to completing the steps, alternative steps, and optional steps described herein include ROM, RAM, HD, a database, a data cartridge, a data backup magnetic tape, a floppy diskette, a flash memory drive, an optical data storage drive, a CD-ROM, non-volatile memories, volatile memories, DASD arrays, magnetic tapes, floppy diskettes, optical storage devices, and any other type of computer-readable medium that can be read by a processor.

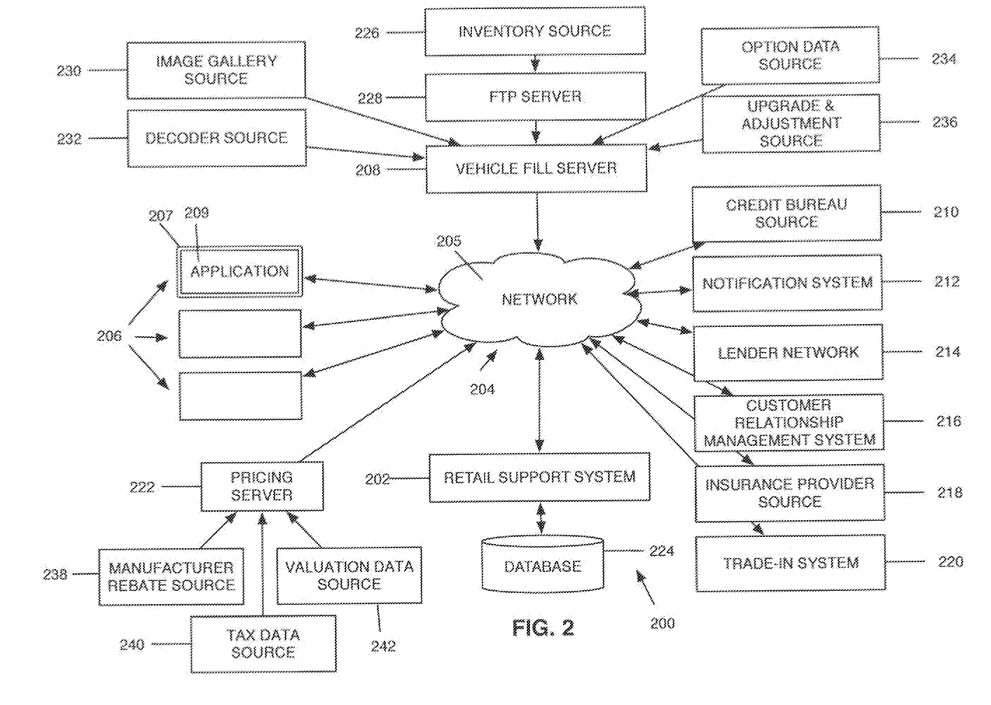

FIG. 2 illustrates an example embodiment of a network 200 that may be used to implement the embodiments of a retail support method, as described herein. The network 200 includes a retail support system 202 that is coupled through a communication network 204 to user devices 206, a vehicle fill server 208, a credit bureau source 210, a notification system 212, a lender network 214, a customer relationship management system 216, an insurance provider source 218, a trade-in system 220, and a pricing server 222. The network 200 provides communication between the retail support system 202 and the user devices 206, the vehicle fill server 208, the credit bureau source 210, the notification system 212, the lender network 214, the customer relationship management system 216, the insurance provider source 218, the trade-in system 220, and/or the pricing server 222 such that it can obtain, pull, data from these external sources. The data obtained by the retail support system 202, as described in more detail herein, can include user data, item data (e.g., vehicle data), inventory data, sales data, credit data, lender data, finance data, customer relations data, insurance data, trade-in data, pricing data, and any other data considered suitable for a particular embodiment. Each of the user devices 206, the vehicle fill server 208, the credit bureau source 210, the notification system 212, the lender network 214, the customer relationship management system 216, the insurance provider source 218, the trade-in system 220, and the pricing server 222 is referred to herein as an “external source” of the retail support system 202 and can comprise one or more computers that are in communication with the retail support system 202 via the network 204 or be included within a computer that includes the retail support system. Each of the external sources is in communication with the retail support system 202 via the network 204, can receive data pushed from the retail support system 202 via the network 204, can push data to the retail support system 202, or allow the retail support system 202 to pull data from the external source. The data received by the retail support system 202 by an external source can be stored in database 224 and/or sent to one or more other external sources and/or a user device.

While some external sources have been described, a retail support method can utilize any suitable number and/or type of external sources and selection of a suitable number and/or type of external sources to utilize in a retail support method can be based on various considerations, including the type of item being purchased by a user. Examples of numbers of external sources considered suitable for a retail support method and/or system to utilize include one, at least one, two, a plurality, three, four, five, six, seven, eight, nine, ten, eleven, twelve, thirteen, fourteen, fifteen, more than fifteen, and any other number considered suitable for a particular embodiment. Examples of the external sources considered suitable to include in a retail support method include one or more user devices, a vehicle fill server, a credit bureau source, a notification system, a lender network, a customer relationship management system, an insurance provider source, a trade-in system, a service department source, a pricing server, and any other external source considered suitable for a particular embodiment.

The communication network 204 can be any suitable communication network and selection of a suitable communication network can be based on various considerations, including the location of a user device relative to a retail support system. Examples of communications networks considered suitable include wired networks, wireless networks, cellular networks, mobile networks, satellite networks, wide area network (WAN), publicly switched telephone network (PTSN), combinations of those described herein, and any other network considered suitable for a particular embodiment. In the illustrated embodiment, the communication network 204 is the Internet 205.

In the illustrated embodiment, an example of a user device 206 is a computer 207 that interacts with the retail support system 202 via the network 204 and an application 209 being executed on the computer 207. In an example embodiment, the retail support system 202 and a user device 206, or each user device of a plurality of user devices, are located at the same property (e.g., sales lot). While an example of a user device has been illustrated, a user device can comprise any suitable device and/or computer, such as a personal computer system, a work station computer system, a laptop computer system, dedicated terminal, an embedded controller system, a microprocessor-based system, a digital signal processor-based system, a wireless system, a wireless networking system, mobile device, a hand held device, mobile telephone, smart phone, electronic device, a personal digital assistant (PDA) system, a wearable device, tablet, kiosk, and/or any other device considered suitable for a particular embodiment.

In the illustrated embodiment, the retail support system 202 includes a database 224 operable to store data such as the data, attributes, and/or instructions stored as software code components or modules relating to the steps, alternative steps, and/or optional steps described herein. The retail support system 202 can comprise one or more computers with central processing units executing instructions embodied on one or more computer readable mediums where the instructions are configured to perform at least some of the steps, alternative steps, and/or optional steps described herein. For example, some of the steps, alternative steps, and/or optional steps described herein may be included on one or more applications (e.g., (API)) stored at database 224 and retail support system 202 can include an application server configured to implement the various steps, alternative steps, and/or optional steps as described herein. An example API can interact with the one or more user devices 206 and one or more external sources in real-time, or pull data from database 224, such that the user is provided with data relating to a retail support method.

Retail support system 202 can utilize one or more interfaces configured to, for example, receive and respond to queries from users at user devices 206; interface with a vehicle fill server 208, a credit bureau source 210, a notification system 212, a lender network 214, a customer relationship management system 216, an insurance provider source 218, a trade-in system 220, and/or a pricing server 222 to push or pull data, which can be stored in database 224; or push data obtained, or organized, by retail support system 202 to any of a vehicle fill server 208, a credit bureau source 210, a notification system 212, a lender network 214, a customer relationship management system 216, an insurance provider source 218, a trade-in system 220, and/or a pricing server 222. An interface utilized may depend on the functionality being implemented, the type of network 204 utilized, the type of data being obtained, presented, or organized, the time interval at which data is obtained, presented, or organized, and/or the type of electronic devices (e.g., computers) utilized. Interfaces may include any suitable interface such as web pages, web services, a data entry or database application to which data can be entered or otherwise accessed by a user, and/or any other type of interface considered suitable for a particular embodiment. The data obtained by retail support system 202 can be grouped, analyzed, organized, or otherwise processed by retail support system 202 to complete one or more of the steps, alternative steps, and/or optional steps described herein. A user at a user device 206 can access the retail support system 202 through the network 204 and specify certain parameters, such as a desired item (e.g., vehicle), using one or more of the user interfaces, as described herein. The retail support system 202 can select or generate data using the data stored in database 224 or obtained from an external source to provide, for example, pricing data, insurance data, and other data, as described herein. Interfaces can be generated from the selected, or generated, data and can be presented to the user at the user device 206.

Each of the user devices 206 is in communication with the retail support system 202 via the network 204 and includes I/O devices such that a user can enter data into the user device 206 that can be pushed to, or pulled from, the retail support system 202 via the network 204. The data obtained by the retail support system 202 from the user device 206 can be stored in database 224 and/or sent to one or more external sources.

In the illustrated embodiment, the vehicle fill server 208 is in communication with the retail support system 202 via the network 204 such that data can be pushed to, or pulled from, the vehicle fill server 208 by the retail support system 202 via the network 204. The vehicle fill server 208 is in communication with an inventory source 226 via an FTP server 228, an image gallery source 230, a decoder source 232 (e.g., yin decoder source in embodiments in which an item is a vehicle), an option data source 234 (e.g., vehicle option data source in embodiments in which the item is a vehicle), and an upgrade and adjustment source 236 (e.g., dealer upgrade and adjustment source in embodiments in which an item is a vehicle) via a second network (not shown) such that the vehicle fill server 208 can push data to, or pull data from, these external sources. These external sources can push data to, or pull data from, the vehicle fill server 208 relating to any suitable attribute of an item, such as sale data, finance data, part data, service data, inventory data, and/or pricing data relating to a specific user affiliated with the sale of an item or set of users affiliated with the sale of an item. The inventory source 226 may be associated with one or more inventory polling companies, inventory management companies, or listing aggregators which may obtain and store inventory data from one or more of users affiliated with the sale of an item. For example, the inventory source 226 may provide real-time data (e.g., unique item identifiers, pricing information, images, attributes) to a vehicle fill server and/or retail support system 202 via the vehicle fill server 208 relating to specific items available by a specific user affiliated with the sale of an item (e.g., retail outlets) during implementation of a retail support method (e.g., images of items available in an inventory). A retail store account can optionally be populated relating to the data received from an inventory source and used to complete one or more of the steps described herein (e.g., a transaction for an item).

The image gallery source 230 may provide images for each item, such as stock photos or images taken from a user selling the item. The image gallery source 230 can be used in any suitable step described herein, such as steps 106 through 116. The decoder source 232 includes data relevant to a specific item (e.g., VIN number, barcode, optional attributes that describe the item). For example, in an embodiment a vehicle yin decoder source can be used such that a VIN number that is obtained via a user device 206 is pulled from the user device 206, to the retail support system 202, and is pushed from the retail support system 202 to the vehicle yin decoder source such that specific vehicle data can be populated and pulled from the vehicle VIN decoder source by the retail support system 202. This allows the retail support system 202 to interact with trade-in system 220 such that a trade-in value can be generated and displayed to a user, as described herein. In an alternative embodiment, any data that is not captured by the decoder source and is required to calculate a trade-in value can be provided by a user using a user device 206 and stored by the retail support system database 224. Data received from a decoder source can be used in any suitable manner. For example, data received from a decoder source can be displayed to a user using a user interface, such as those described herein (e.g., all data provided in a user interface other than selectable items and images can be received from a decoder source). The option data source 234 provides data relating to a list of all available options for an item such that they can be displayed to a user using a user interface, such as those described herein. The upgrade and adjustment source 236 provides a user affiliated with the sale of an item to add upgrades and/or price-markups to particular items within an inventory. For example, a user affiliated with the sale of an item could add aluminum wheels to all vehicles in an inventory and markup each vehicle by $2000 as a result of the upgrade.

The credit bureau source 210 is in communication with the retail support system 202 via the network 204 such that data can be pushed to, or pulled from, the credit bureau source 210 by the retail support system 202 via the network 204. The credit bureau source 210 includes data that relates to a user's credit, which, as described in more detail herein, can be used to present one or more financing options to a user. For example, retail support system 202 can pull credit data (e.g., in real-time, based on data from driver's license) relating to a user from the credit bureau source 210 via the network 204 while a retail support method is being utilized. The credit bureau source 210 can include data receive from a credit reporting agency, such as Equifax, Transunion, and/or Experian.

The notification system 212 is in communication with the retail support system 202 via the network 204 such that data can be pushed to, or pulled from, the notification system 212 by the retail support system 202 via the network 204. The notification system 212 provides data relating to a user interested in purchasing an item to a user affiliated with selling the item (e.g., manager), request that a user affiliated with the sale of an item meet with a user intending purchasing the item, send a notification (e.g., email) to a user affiliated with selling an item that includes a summary of an interaction and/or compliance documents to the user intending on purchasing the item after a visit to a location where an item is located (e.g., showroom, sales floor) and/or purchase of an item. A notification can be utilized to transmit data relating to a transaction to one or more parties affiliated with the purchase of an item.

The lender network 214 is in communication with the retail support system 202 via the network 204 such that data can be pushed to, or pulled from, the lender network 214 by the retail support system 202 via the network 204. The lender network 214 is configured to provide data relating to one or more financing options to a user. The lending network 214 can be associated with any entity such as a bank, savings and loan, or credit union that provides any type of financial services to a user involved in the purchase of an item. For example, when a user desires to purchase an item, they can use one or more of the methods, steps, optional steps, and/or alternative steps described herein to apply for a loan from a financial institution in communication with the retail support system 202 via the lender network 214, such that a loan application and contract can be completed relative to the item using one or more of the methods, steps, optional steps, and/or alternative steps described herein.

The customer relationship management system 216 is in communication with the retail support system 202 via the network 204 such that data can be pushed to, or pulled from, the customer relationship management system 216 by the retail support system 202 via the network 204. Data pushed to the customer relationship management system 212 is used to send notifications to a user (e.g., email, text message, phone call) regarding scheduling an event, such as an item delivery time, via the network 204.

The insurance provider source 218 is in communication with the retail support system 202 via the network 204 such that data can be pushed to, or pulled from, the insurance provider source 218 by the retail support system 202 via the network 204. The insurance provider source 218 is configured to provide data relating to one or more insurance options to a user. The insurance provider source 214 can be associated with any entity such as one or more insurance companies that provide any type of insurance service to a user involved in the purchase of an item, such as a vehicle. For example, when a user purchases an item they may desire to obtain a quote (e.g., firm quote) for insurance, such that a loan application and contract can be completed relative to the item using one or more of the methods, steps, optional steps, and/or alternative steps described herein.

The trade-in system 220 is in communication with the retail support system 202 via the network 204 such that data can be pushed to, or pulled from, the trade-in system 220 by the retail support system 202 via the network 204 relating to an item (e.g., previously owned item, item owned by the user). The trade-in system 220 is configured to provide data relating to a trade-in value to a user. The trade-in system 220 can be associated with any entity such as one or more dealers that accept trade-in items, such as an entity associated with an item being purchased by the user, or an entity separate from the entity associated with an item being purchased by the user. For example, when a user purchases an item they may wish to trade-in a previously owned item. Data relating to the user and the trade-in item can be push from, or pulled from, a user device 206 to the retail support system 202 and then pushed to the trade-in system 220 such that a trade-in value can be calculated by the trade-in system 220 and provided to the user via the network 204.

In the illustrated embodiment, the pricing server 222 is in communication with the retail support system 202 via the network 204 such that data can be pushed to, or pulled from, the pricing server 222 by the retail support system 202 via the network 204. The pricing server 222 is in communication with a manufacturer rebate source 238, a tax data source 240, and a valuation data source 242 via a second network (not shown) such that the pricing server 222 can push data to, or pull data from, these external sources. These external sources may provide various data relating to rebates, taxes, and/or valuations that are currently applicable to a user and/or an item, such as manufacturing rebates, tax data (e.g., specific to a user and/or item), such as federal tax data, state tax data, county tax data, and/or local tax data, and/or valuation data. For example, the pricing server 222 can parse tax rules such that data can be pulled by retail support system 202 and/or the manufacturer rebate source 238 can check all available discounts and/or rebates for a given item. Discounts and/or rebates can include flat cash rebates, variable discounts (e.g., buy 2 get 1 free), and/or loan interest rate discounts (e.g., 0% APR). Discounts and/or rebates can vary by region and/or by item. The valuation data source 242 can pull auction value for one or more items and provides a mechanism to a user affiliated with selling an item to determine whether they are selling an item within fair market range and provide the user affiliated with selling the item determine whether any trade-in items will be obtained at a profitable rate. For example, a user affiliated with selling an item can check the value of an item being traded in using the data received from the valuation data source 242 and credit the user purchasing an item in the amount determined from the data received from the valuation data source 242 toward the purchase price of the item being purchased. The data received from a tax data source 240 can be used to calculate a final purchase price for an item and/or used in calculating a loan and/or lease amount.

Optional other data sources can be used in the methods described herein. For example, a service department data source can include a data received from a dealership service department and/or a retail store. The data can include item data from past service records, present service records, and/or future service records that can be used to complete one or more of the steps described herein and/or provided to a user using a user interface, such as those described herein, such that a user purchasing an item can utilize the data in determining whether to purchase the item. Optionally, a service department system can be in communication with a retail system such that when a user brings an item in for service (e.g., vehicle that requires new engine), the service department system communicates with the retail system such that a user affiliated with selling an item can communicate with the user who brought the item in for service and complete one or more of the steps described herein. This allows for services requests to be tied to the sale of an item and/or the sale of an item to service requests (e.g., when a user purchases an item, a service department can be notified such that service requests can be scheduled and affiliated with the item and the user that purchased the item).

Turning now to retail support method 100, step 102 can be accomplished by obtaining one or more attributes associated with each item of a plurality of items using any suitable technique or method. For example, one or more attributes can be obtained by the retail support system 202 pulling data from one or more, or each, of the database 224 and/or the external sources, such as the user devices 206, the vehicle fill server 208, the credit bureau source 210, the notification system 212, the lender network 214, the customer relationship management system 216, the insurance provider source 218, the trade-in system 220, and/or the pricing server 222 in real-time or from database 224 or another database.

An item for which an attribute is obtained can be any suitable item and selection of a suitable item can be based on various considerations, including the type of item desired to be purchased by a user. Examples of items considered suitable to obtain one or more attributes include retail items, such as vehicles, pieces of furniture, appliances, clothing, items available at a particular location (e.g., sales lot), items available by a particular owner (e.g., dealer), items available within a particular region (e.g., county, state, country, radius), combinations of those described herein, and any other item considered suitable for a particular embodiment. An attribute associate with an item can be any suitable attribute and selection of a suitable attribute to obtain for an item can be based on various considerations, including the type of item. Examples of attributes considered suitable to obtain relative to an item include attributes that relate to a specific quality or characteristic of an item, such as a style, feature, make, model, ownership history, price, manufacturing date, model year, mileage, color of the item, trim, power train, option, and/or any other attribute considered suitable for a particular embodiment.

Step 104 can be accomplished by organizing the one or more attributes such that one or more of the attributes of each item of the plurality of items is grouped within a class having a class identifier using any suitable technique or method of organizing data. This step can be accomplished in real-time as an application is running the retail support method and/or completed before a retail support method is initiated. A class identifier can be any suitable representation of a group of attributes and selection of a suitable class identifier can be based on various considerations, including the type of attributes grouped within a particular class. Examples of types of class identifiers include names, titles, representative figures, and any other class identifier considered suitable for a particular embodiment. The grouped attributes, the classes, and the class identifiers can be stored within database 224 such that they can be accessed and pushed to a user device 206 and displayed to a user via a user interface, as described in more detail herein.

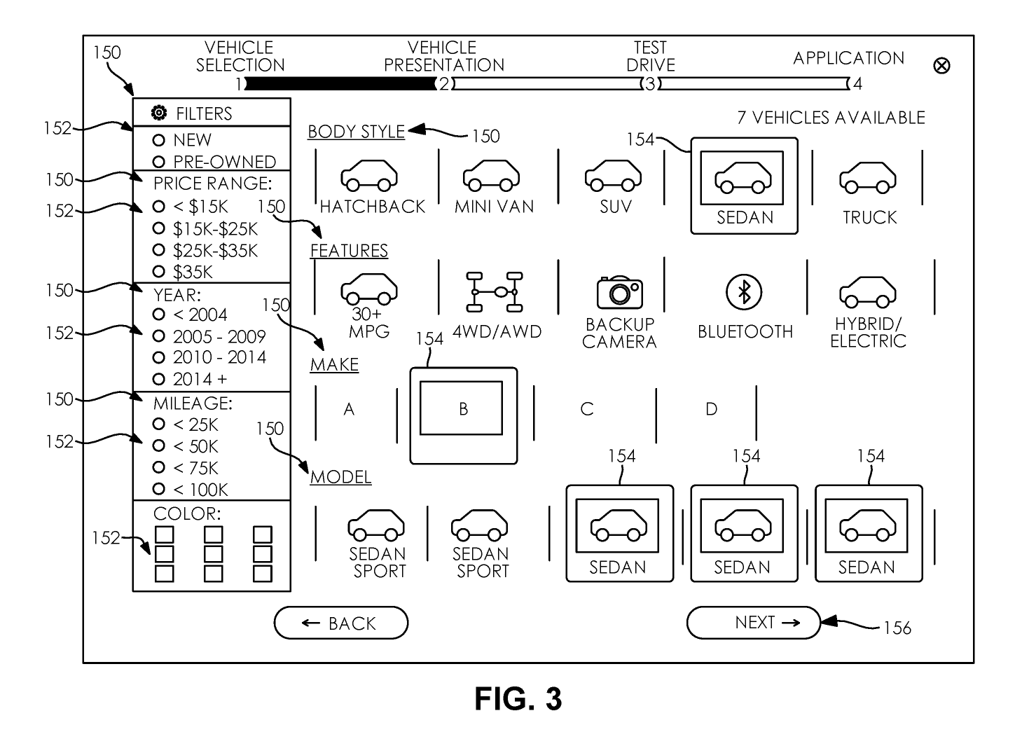

Step 106 can be accomplished using any suitable technique or method of providing an interactive user interface that displays to a user one or more of the class identifiers and provides a first user interface element for selecting one or more of the class identifiers to a user. As illustrated in FIG. 3, class identifiers 150 relating to whether the item is new, price range, year, mileage, color, body style, features, make, and model are displayed to the user and relate to attributes associated with one or more vehicles. The attributes for each vehicle have been organized within the class identifiers 150 such that a user selection of one or more of the class identifiers 150 limits data pulled by the retail support system 202 and the number of items that will be displayed to the user in step 110. Selection of a suitable technique or method of providing a first interactive user interface to a user can be based on various considerations, including the type and number of class identifiers being displayed to the user. Examples of techniques and methods of providing a first interactive user interface to a user include using a web browser, a web page, an application program, a multimedia framework, a media player, a media library application, an API, a SDK, combinations of the techniques and methods described herein, and/or any other technique or method considered suitable for a particular embodiment.

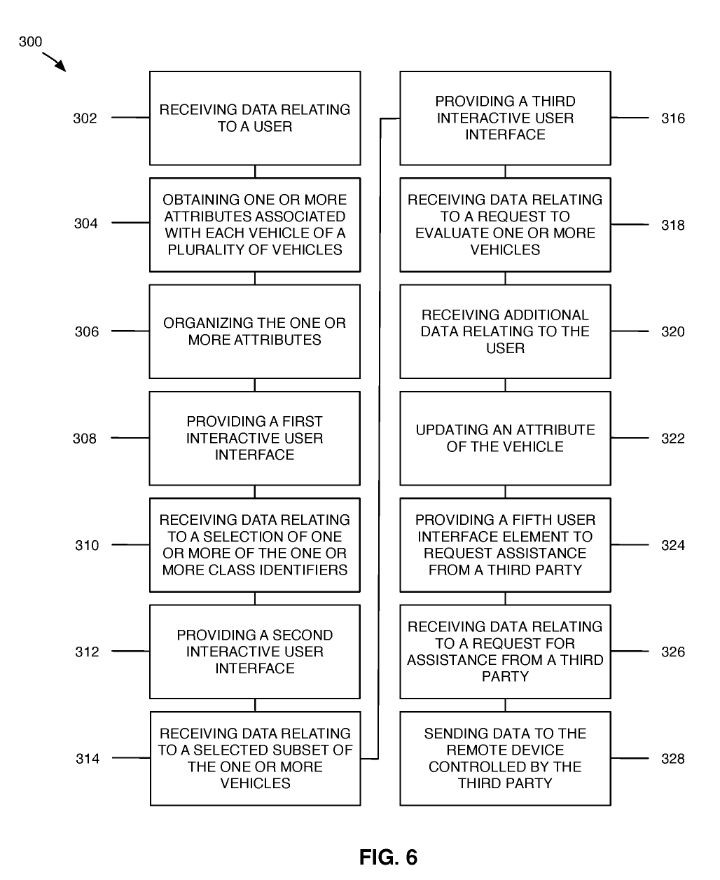

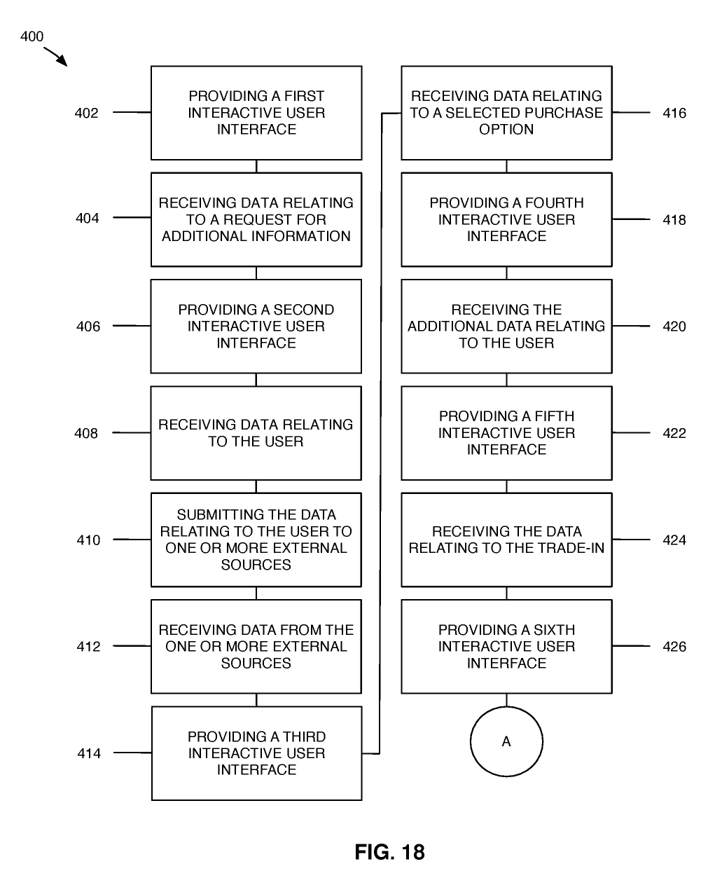

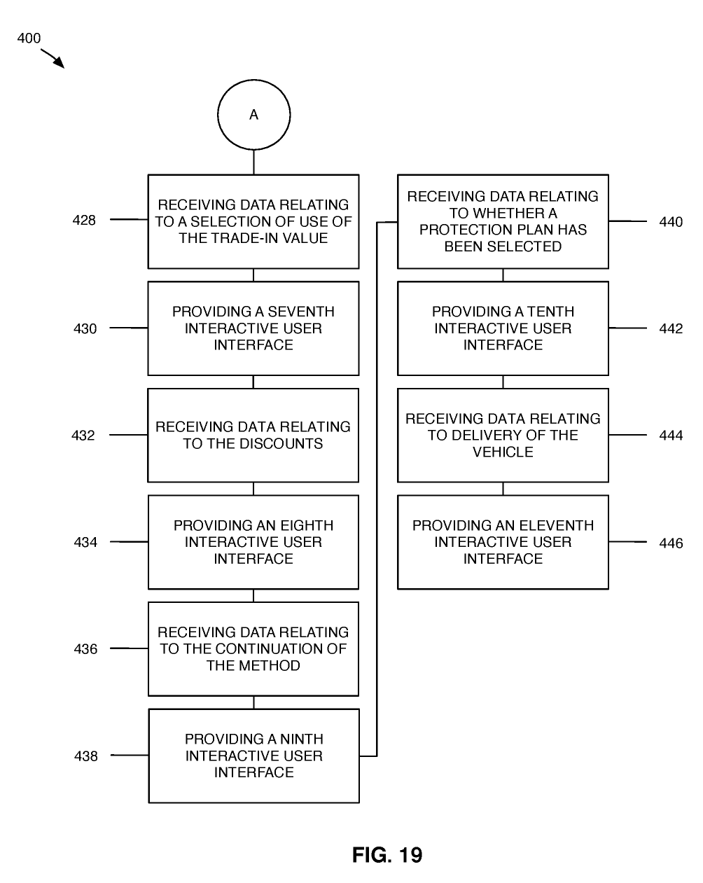

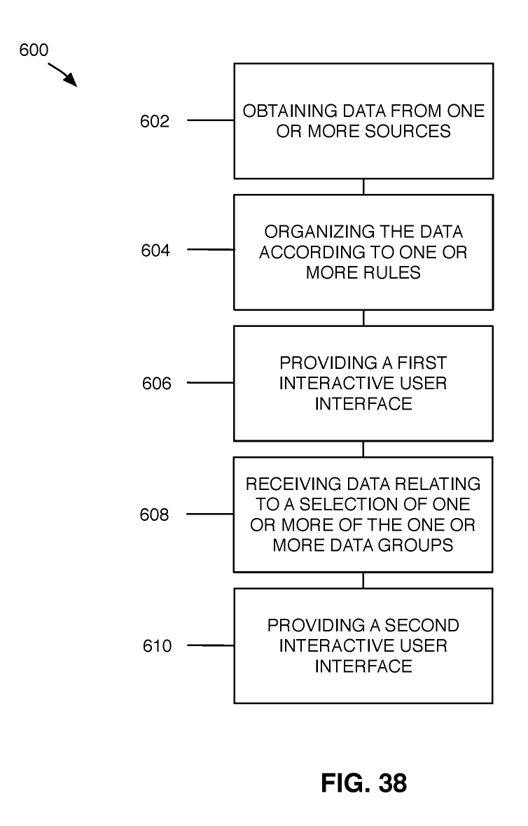

For example, the methods described herein can be implemented by a user activating an application program that can be downloaded, or has already been downloaded, onto a user device 206 and accessed by the user via the user device 206. The application program can include computer executable instructions that allow the user device 206 to interact with the retail support system 202 to complete the methods, steps, alternative steps, and/or optional steps disclosed herein (e.g., method 100 illustrated in FIG. 1, method 300 illustrated in FIG. 6, method 400 illustrated in FIGS. 18 and 19, method 600 illustrated in FIG. 38). A first interactive user interface can be provided to a user device 206 from the retail support system 202 via the network 204 and can be displayed to the user via the user device 206. Alternatively, the methods, steps, optional steps, and/or alternative steps disclosed herein can be implemented via a website over the network 204 and operated by the retail support system 202 that is accessible by the user using the user device 206 (e.g., via a web browser) such that the user can complete a retail support method, as described herein. In the illustrated embodiment, a portion, or the entirety, of the steps, alternative steps, and/or optional steps described herein can be accessible to the user while the user is offline (e.g., the user is not connected to a network) or while the user is online (e.g., while the user is connected to a network).

Any suitable type of user interface element can be provided to a user for selecting one or more of the class identifiers and selection of a suitable user interface element can be based on various considerations, including the number of class identifiers provided to a user on an interactive user interface and the type of interactive user interface provided to a user. Examples of user interface elements considered suitable to provide to a user to select one or more class identifiers, or any other item described herein, include text boxes, sliders, drop-down menus, radio buttons, soft buttons, electronic buttons, selectable buttons, icons, selectable icons, images, selectable images, hardware elements, such as buttons, buttons on a keypad, switches, scroll wheels, microphones, cameras, any combination of the user interface elements described herein, including those on a touch screen display, and any other user interface element considered suitable for a particular embodiment. Any suitable number of user interface elements can be provided on each user interface described herein, such as one, at least one, two, a plurality, three, four, five, more than five, and any other number considered suitable for a particular embodiment. As shown in FIG. 3, the user interface element for selecting one or more of the class identifiers include selectable buttons 152 and selectable images 154, which can be obtained from an image gallery source 230.

An optional step comprises receiving data relating to a user such that a user account can be created. This optional step can be accomplished by presenting a user with a form (e.g., via a user interface) that requests data from the user. The data requested from the user to create a user account can include any suitable data, such as identifying information, a user's date of birth, name, mailing address, a password, login information relating to a user's third party account, such as a social media account, social security data, income data, and any other data considered suitable for a particular embodiment. Once created, a user's account is associated with the data provided by the user, the data provided by the retail support system, data related to an item of interest, and/or any other data considered suitable for a particular embodiment. The user's account information can be used to track the user's location within a retail support method, such as those described herein. For example, once a user account has been created, a sales lead can be created and stored within database 224 and a notification can optionally be sent to one or more users affiliated with the sale of the item via notification system 212.

Step 108 can be accomplished using any suitable technique or method of receiving data relating to a selection made by the user of one or more of the one or more class identifiers. For example, once a user utilizes a user interface element for selecting one or more of the class identifiers, such as by clicking on a selectable button 152 and/or selectable image 154 provided on the user device 206 and submits the selections (e.g., by pressing the user interface element 156, as shown in FIG. 3) to the retail support system 202, data is pushed to, or pulled by, the retail support system 202 from the user device 206 such that the data is received by the retail support system 202.

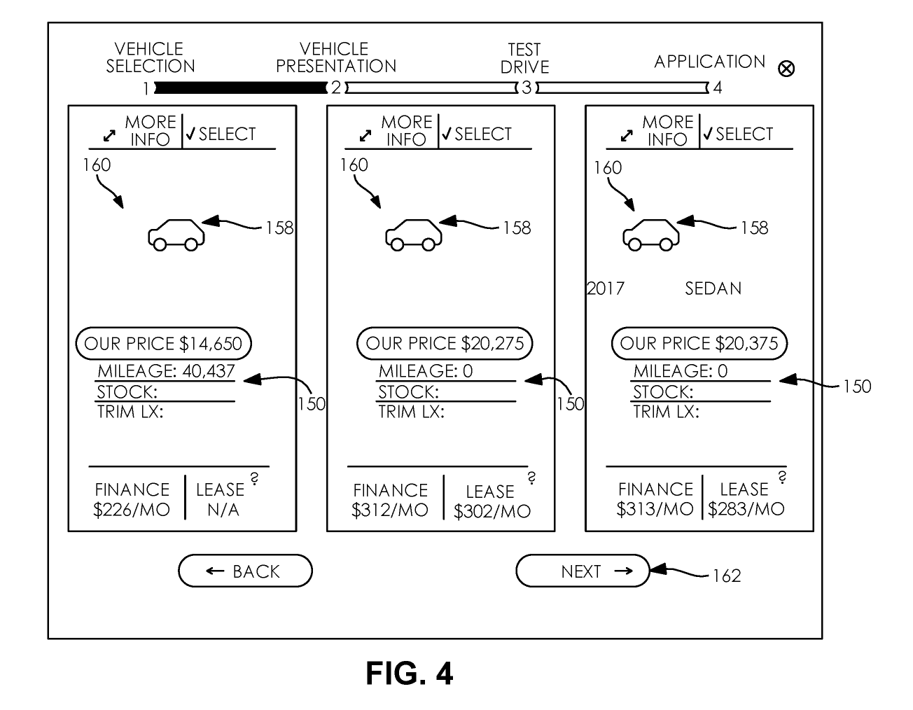

Step 110 can be accomplished using any suitable technique or method of providing an interactive user interface to a user, such as those described above with respect to step 106. As illustrated in FIG. 4, three items (e.g., vehicles) 158 are displayed to the user and are based on the received data relating to the selection made by the user of one or more of the one or more class identifiers. When an item is described as being displayed to a user, the item can be displayed using an image of the item, such that an image of the item is displayed to a user, using a video, such that a video that references the item is displayed to a user, or using any other suitable method or technique of displaying an object to a user. Any of the images and/or videos of the items can be obtained from an image gallery source 230. As shown in FIG. 4, the items 158 are displayed with associated class identifiers 150 relating to attributes associated with the item 158, such as mileage, trim type, and price. For example, each item displayed to the user will be associated with at least one attribute grouped within the class identifiers selected by the user. Alternatively, each item displayed to the user will be associated with the largest number of class identifiers selected by the user relative to the other items (e.g., the best matching item). As shown in FIG. 4, the user interface element for creating a selected subset that comprises one or more items includes selectable icons 160. For example, one or more of the selectable icons 160 can be selected to create the selected subset of items. It is considered advantageous to allow a user to compare one or more items such that they can determine which attributes they desire to be included in the item that is ultimately purchased.

Step 112 can be accomplished using any suitable technique or method of receiving data relating to the selected subset of the one or more items. For example, once a user utilizes a user interface element for creating a selected subset that comprises one or more items, such as by clicking on a user interface element 160 provided on the user device 206 and submits the selections (e.g., by pressing user interface element 162, as shown in FIG. 4) to the retail support system 202, data is pushed to, or pulled by, the retail support system 202 from the user device 206 such that the data is received by the retail support system 202. Optionally, once a user selects one or more items, database 224 can store the selected item and associate the item with a user account as an item of interest.

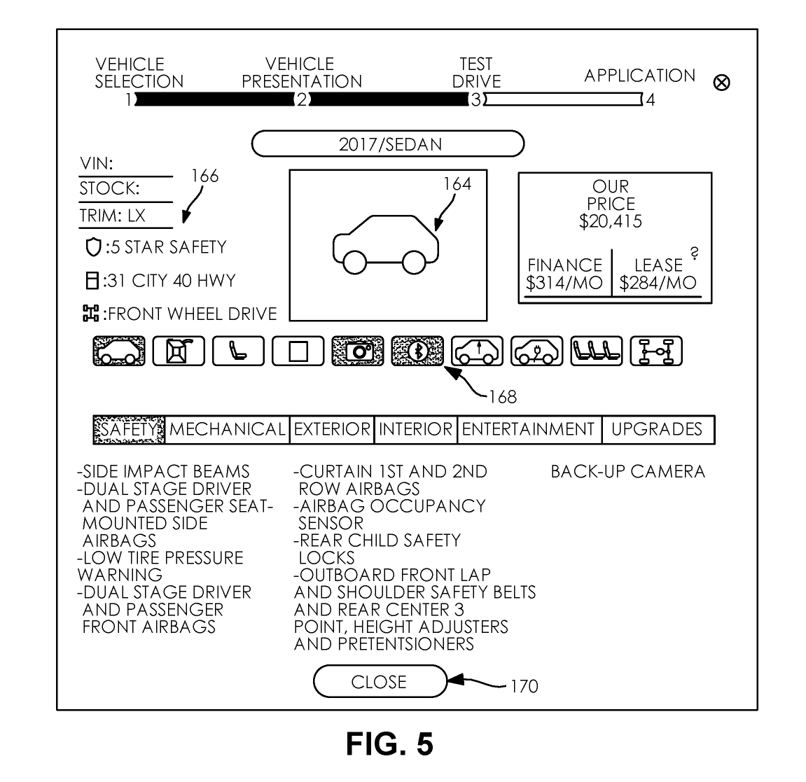

Step 114 can be accomplished using any suitable technique or method of providing an interactive user interface to a user, such as those described above with respect to step 106. As illustrated in FIG. 5, the selected subset of the one or more items 164 that has been selected by the user is displayed and is based on the received data relating to the selected subset of the one or more items. Images of the subset of the one or more items can be obtained from an image gallery source 230. In addition, the item 164 that has been selected by the user is displayed with associated attributes 166 and/or class identifiers 168. As shown in FIG. 5, the user interface element for submitting a request to evaluate one or more items of the selected subset of the one or more items includes a selectable button 170. A request to evaluate an item can be based on the type of item. For example, if the item is a vehicle, the request to evaluate the item can be a request to test drive the vehicle. Alternatively, if the item is a mattress, the request to evaluate an item can be a thirty-day trial of the mattress.

Step 116 can be accomplished using any suitable technique or method of making the one or more items of the selected subset available to the user for evaluation. Selection of a suitable technique or method can be based on various considerations, including the type of item being evaluated. Examples of suitable techniques and methods of making the one or more items available to the user for evaluation include removing the one or more items of the selected subset from the plurality of items, moving the one or more items to a location accessible to the user, mailing the one or more items of the selected subset to the user, shipping the one or more items of the selected subset to the user, and any other technique or method considered suitable for a particular embodiment.

Optionally, if a user is presented with a user interface and stops progressing through the retail support method (e.g., by closing a web page, closing out an application, loading a new web page, remains idle for a predetermine amount of time (e.g., five, minutes, ten minutes)), an optional step comprises receiving data relating to the termination of progress of the retail support method and data relating to a user's location within the method. Such data can be pushed by, or pulled from, the user device to the retail support system such that it is received by the retail support system and associated with a user (e.g., user account). For example, data associated with the selection of any user interface elements by a user but not submitted to the retail support system (e.g., by clicking next) can be stored within a retail support system database such that another user, such as a salesperson, can follow up with the user at a later date regarding completing a transaction or determining why the retail support method was not completed.

While various steps, alternative steps, and optional steps have been described above with respect to method 100, these steps, alternative steps, and optional steps can be included in, accomplished concurrently with, and/or accomplished in the alternative to, the other methods, steps, alternative steps, and/or optional steps described herein, such as those included in method 300, method 400, and/or method 600.

FIG. 6 is a schematic illustration of another retail support method 300.

A step 302 comprises receiving data relating to a user. Another step 304 comprises obtaining one or more attributes associated with each vehicle of a plurality of vehicles, each attribute based on a specific quality of each vehicle of the plurality of vehicles. Another step 306 comprises organizing the one or more attributes such that one or more of the attributes of each vehicle of the plurality of vehicles is grouped within a class having a class identifier. Another step 308 comprises providing a first interactive user interface that displays to a user one or more of the class identifiers and provides a first user interface element for selecting one or more of the class identifiers. Another step 310 comprises receiving data relating to a selection made by the user of one or more of the one or more class identifiers. Another step 312 comprises providing a second interactive user interface that displays to the user one or more of the vehicles based on the received data relating to the selection of one or more of the one or more class identifiers and provides a second user interface element for creating a selected subset that comprises one or more vehicles of the one or more of the vehicles. Another step 314 comprises receiving data relating to the selected subset of the one or more vehicles. Another step 316 comprises providing a third interactive user interface that displays the selected subset of the one or more vehicles, the attributes associated with the selected subset of the one or more vehicles, and provides a third user interface element for submitting a request to evaluate one or more vehicles of the selected subset of the one or more vehicles, and provides a fourth user interface element to request additional information relating to the purchasing the vehicle. Another step 318 comprises receiving data relating to a request to evaluate one or more vehicles of the selected subset of the one or more vehicles. Another step 320 comprises receiving additional data relating to the user based upon the receipt of data relating to the request to evaluate one or more vehicles of the selected subset of the one or more vehicles. Another step 322 comprises updating an attribute of the vehicle such that the vehicle is designated as being evaluated. Another step 324 comprises providing a fifth user interface element to request assistance from a third party such that a notification is sent to a remote device controlled by the third party when data relating to a request for assistance from a third party is received. Another step 326 comprises receiving data relating to a request for assistance from the third party. Another step 328 comprises sending the data relating to the request for assistance from the third party, data relating to the user, data relating to the selection of one or more of the one or more class identifiers, and data relating to a selected subset to the remote device controlled by the third party.

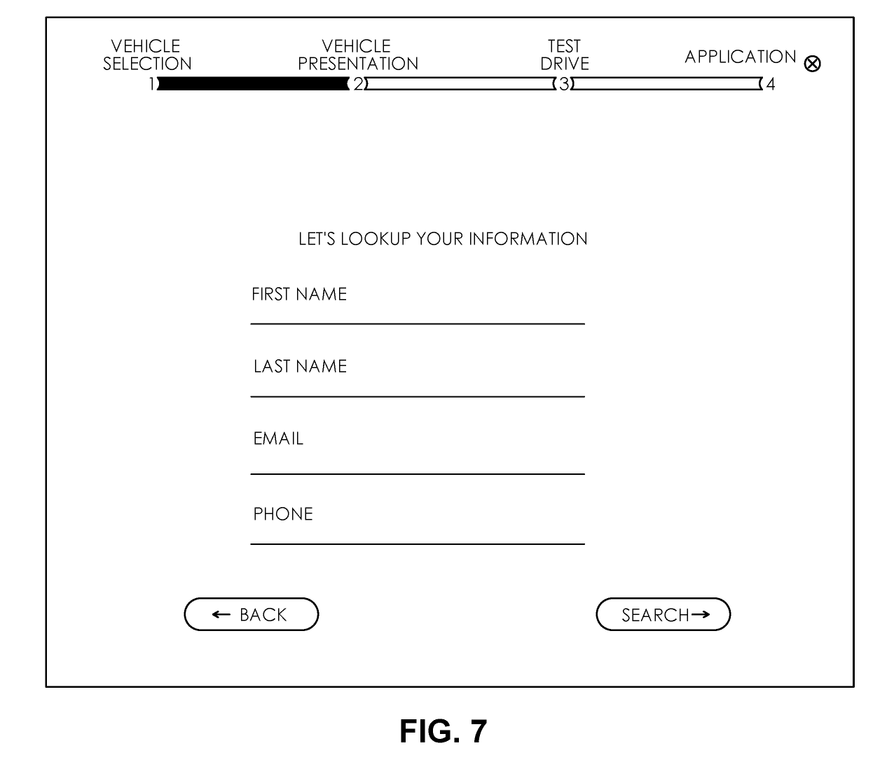

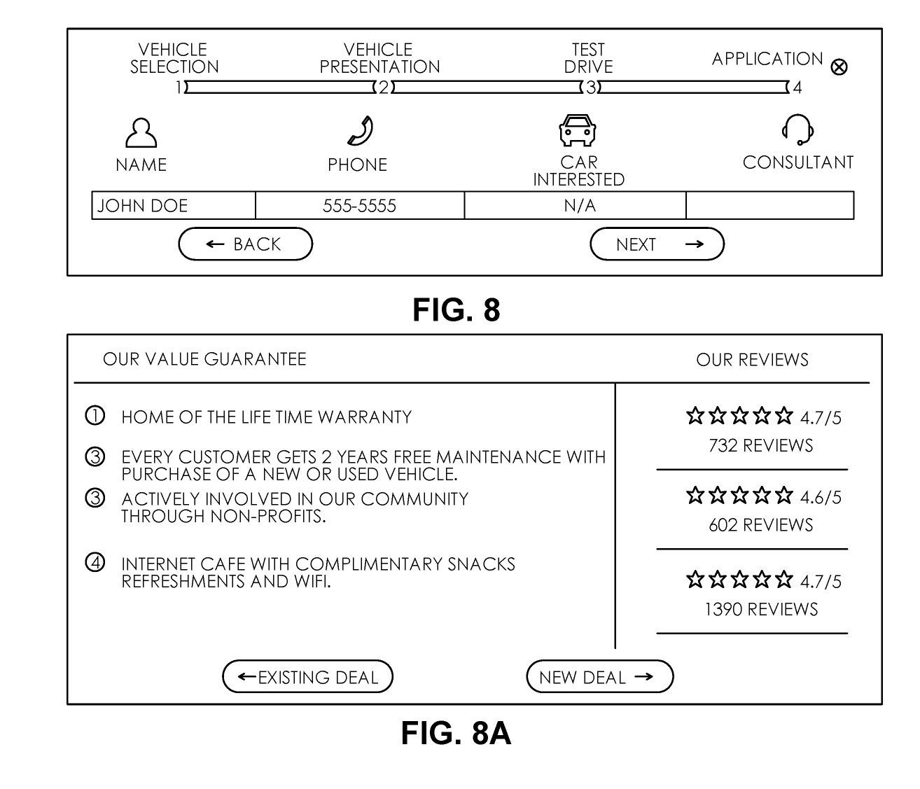

Step 302 can be accomplished using any suitable technique or method of receiving data relating to a user. For example, an interactive user interface can be provided to a user that displays one or more fields that request user data. The fields can request a username and password, or as shown in FIG. 7, can request a first name, last name, an email address, and phone number of the user such that a user account can be created or accessed. Once data has been entered into the fields, it can be submitted to the retail support system (e.g., by pressing user interface element (e.g., search button) in FIG. 7) such that it is received by the retail support system. If a user account exists, an interactive user interface can be displayed to a user that displays data associated with the existing account, as shown in FIG. 8. In an alternative embodiment, a unique dealer interactive user interface can be displayed prior to step 302 being completed, as shown in FIG. 8A. A unique dealer interactive user interface can include any suitable data desired by a dealer, such as review data, maintenance data, warranty data, features of the dealer, and any other data considered suitable for a particular embodiment.

Step 304 can be accomplished as described above with respect to step 102. However, with respect to step 304, each attribute is based on a specific quality of each vehicle of the plurality of vehicles.

Step 306 can be accomplished as described above with respect to step 104. However, with respect to step 306, each attribute is organized such that one or more of the attributes of each vehicle of the plurality of vehicles is grouped within a class having a class identifier.

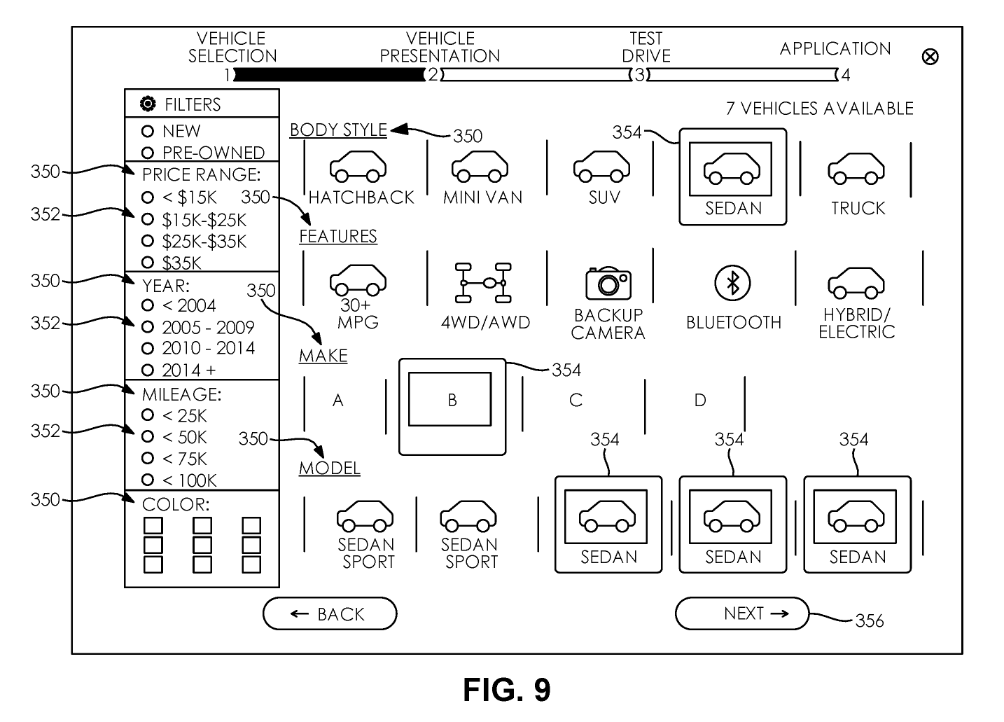

Step 308 can be accomplished as described above with respect to step 106. FIG. 9 illustrates an example first interactive user interface that displays one or more of the class identifiers 350 and the first user interface element for selecting one or more of the class identifiers include selectable buttons 352 and selectable images 354.

Step 310 can be accomplished as described above with respect to step 108. For example, once a user utilizes a user interface element for selecting one or more of the class identifiers, such as by clicking on a selectable button 352 and/or selectable image 354 provided on the user device 206 and submits the selections (e.g., by pressing user interface element 356, as shown in FIG. 9) to the retail support system 202, data is pushed to, or pulled by, the retail support system 202 from the user device 206 such that the data is received by the retail support system 202.

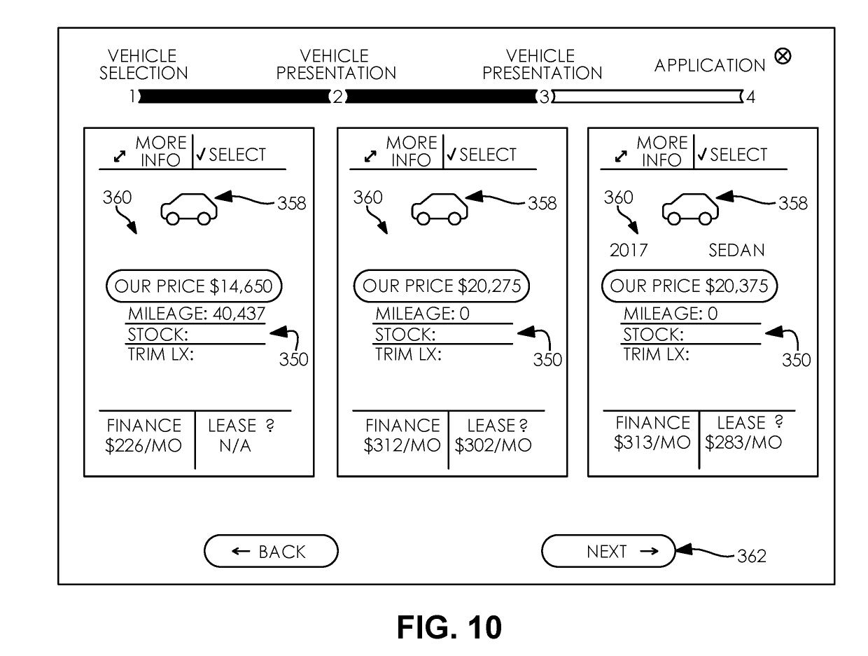

Step 312 can be accomplished as described above with respect to step 110. FIG. 10 illustrates an example second interactive user interface that displays three vehicles 358 to the user and are based on the received data relating to the selection made by the user of one or more of the one or more class identifiers 350. In addition, the vehicles 358 are displayed with associated class identifiers 350 relating to attributes associated with the item 358, such as mileage, trim type, and price. As shown in FIG. 10, the user interface element for selecting one or more of the vehicles include selectable icons 360.

Step 314 can be accomplished as described above with respect to step 112. For example, once a user utilizes a user interface element for selecting one or more of the items, such as by clicking on a selectable icon 360 provided on the user device 206 and submits the selections (e.g., by pressing user interface element 362, as shown in FIG. 10) to the retail support system 202, data is pushed to, or pulled by, the retail support system 202 from the user device 206 such that the data is received by the retail support system 202.

In embodiments in which step 308, step 310, step 312, and step 314 have been completed in a previous session by the user, these steps can be omitted from method 300 and an interactive user interface can be displayed to a user that displays existing deals relating to the previously entered data to the user such that the user does not have to repeat step 308, step 310, step 312, and step 314. An existing deal displayed to a user can include prepopulated data that relates to previously received data, such as data that relates to a user, an item of interest, and/or another user (e.g., salesperson).

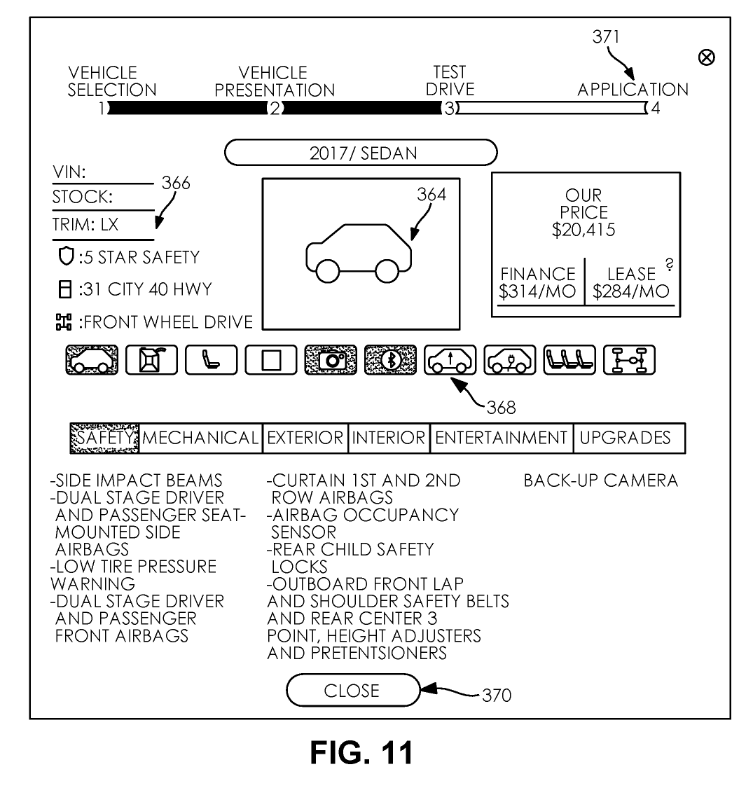

Step 316 can be accomplished as described above with respect to step 114. FIG. 11 illustrates an example third interactive user interface that displays the selected subset of the one or more vehicles 364 and is based on the received data relating to the selected subset of the one or more vehicles. In addition, the vehicle 364 that has been selected by the user is displayed with associate attributes 366 and/or class identifiers 368. As shown in FIG. 11, the user interface element for submitting a request to evaluate one or more vehicles of the selected subset of the one or more vehicles includes a selectable button 370 and the user interface element to request additional information relating to the purchasing the vehicle includes a selectable button 371.

Step 318 can be accomplished using any suitable technique or method of receiving data relating to a request to evaluate one or more vehicles of the selected subset of the one or more vehicles. For example, once a user utilizes a user interface element to request to evaluate one or more vehicles of the selected subset of the one or more vehicles, such as by clicking on selectable button 370 provided on the user device 206 and submits the selection (e.g., by pressing user interface element 370, as shown in FIG. 11) to the retail support system 202, data is pushed to, or pulled by, the retail support system 202 from the user device 206 such that the data is received by the retail support system 202.

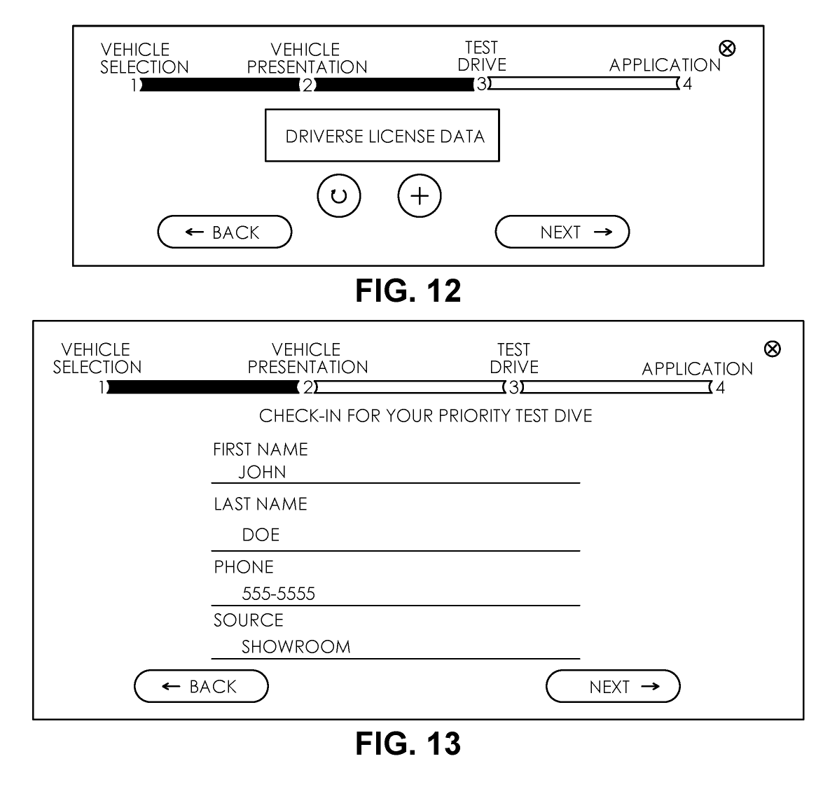

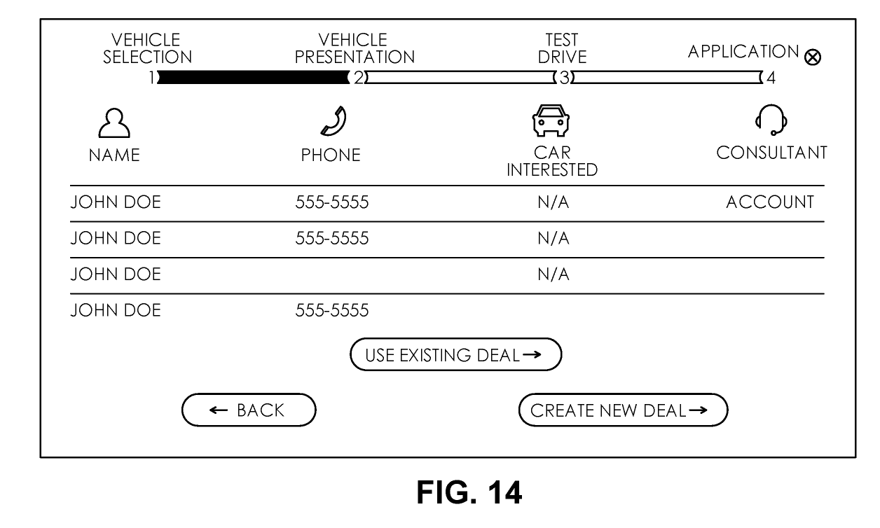

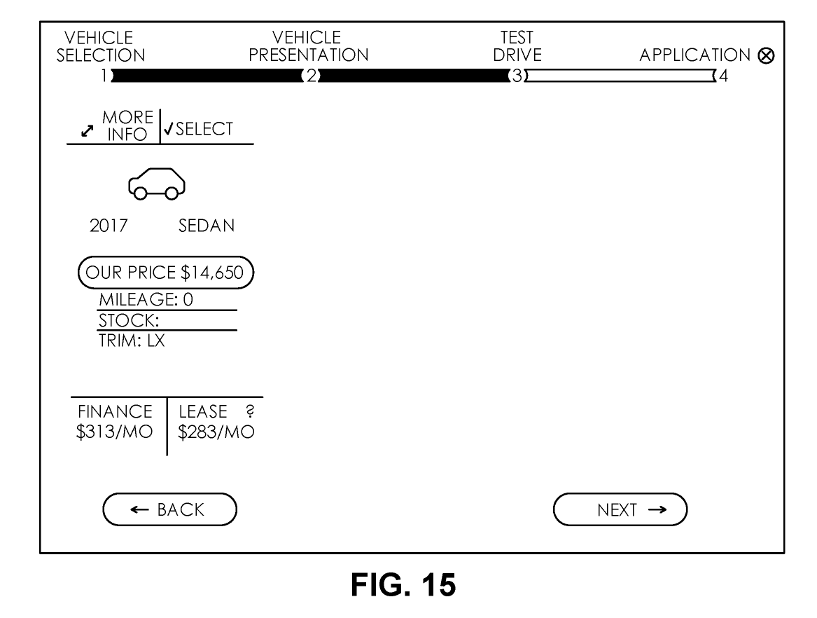

Step 320 can be accomplished using any suitable technique or method of receiving additional data relating to a user. For example, an interactive user interface can be provided to a user that displays one or more fields requesting that additional data relating to the user be input into the fields. The fields can request user data relating to driver's license data, insurance data, driver's license bar code data, driving history data, and any other data considered suitable for a particular embodiment. Once data has been entered into the fields, it can be submitted to the retail support system such that it is received by the retail support system. For example, a user can upload an electronic image of his or her driver's license, as illustrated in FIG. 12, or an insurance data (e.g., insurance card) such that data associated with the driver's license can be pulled by the retail support system 202 and stored in database 224. In an alternative embodiment, various other interactive user interfaces can be displayed to the user to obtain additional data relating to a request to evaluate a vehicle and such data can be pushed to, or pulled by, the retail support system 202 to update an attribute of the vehicle and/or store the data in database 224. For example, FIGS. 13 through 16 illustrate additional interactive user interfaces that can be provided to a user that display data relating to a request to evaluate a vehicle. Optionally, the additional data received regarding a request to evaluate an item can be accessed, or sent to, another user, such as a salesperson, via a notification such that the status of the evaluation (e.g., test drive) can be presented to the user.

Step 322 can be accomplished using any suitable technique or method of updating an attribute of the vehicle. For example, an attribute associated with the status of the vehicle as being on location, or in storage, and stored within database 224, or within a database of an external source, can be updated such that the attribute is designated as being evaluated by a user. Optionally, when an evaluation is complete, the attribute can be updated such that it is designated as being on location or in storage.

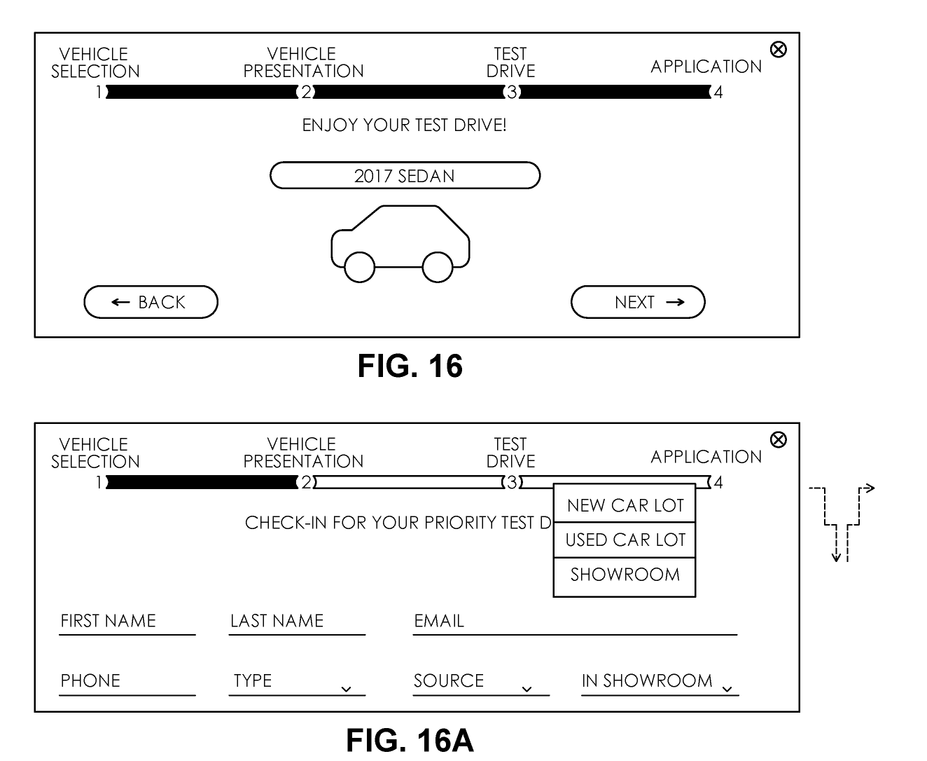

Step 324 can be accomplished by providing any suitable user interface element to request assistance from a third party such that a notification is sent to a remote device controlled by the third party when data relating to a request for assistance from a third party is received. In the illustrated embodiment, the user interface element includes a slide-bar that includes an electronic button and can be accessed by a user via the user device 206. The slide-bar is not visible to the user and is only accessible if the user has knowledge as to where it is located. An example user interface that includes a slide-bar is illustrated in FIG. 16A, which illustrates the swipe code for accessing the slide bar. For example, if the user (e.g., salesperson) determines that it is desired to involve a second user (e.g., manager) in a transaction, the slide-bar can be accessed and the electronic button can be activated (e.g., selecting position of user (e.g., new car lot, used car lot, showroom)). A third party can be any suitable person, such as a user, or other person associated with the sale of an item, such as a vehicle. The user interface element can be provided on any suitable interactive user interface, such as each of, or one of, the interactive user interfaces described herein, and accessed using any suitable remote device, such as a computer (e.g., smart phone).

Step 326 can be accomplished using any suitable technique or method of receiving data relating to a request for assistance from the third party. For example, once a user utilizes a user interface element for requesting assistance from a third party, such as by clicking on the electronic button included on the slide-bar provided on the user device 206, data is pushed to, or pulled by, the retail support system 202 from the user device 206 such that the data is received by the retail support system 202.

Step 328 can be accomplished using any suitable technique or method of sending data relating to the request for assistance from the third party, data relating to the user, data relating to the selection of one or more of the one or more class identifiers, and data relating to the selected subset to the remote device controlled by the third party. For example, data stored on the database 224 can be accessed by the retail support system 202 and sent to the third party's user device 206 via the network 204 such that the third party can review the data prior to engaging contact with the user. In some embodiments, the third party is located on the property where the user and/or vehicle is located. Alternatively, the third party can be located on a property that is different than the property where the user and/or vehicle is located. For example, a third party can be located at a first property and a user and/or vehicle can be located at a second property. In embodiments in which the third party desires to communicate with a user, the third party can locate the user on the property, or, if the third party is located at a different property, the third party can communicate with the user via the network 204 and one or more user devices 206 (e.g., video chat).

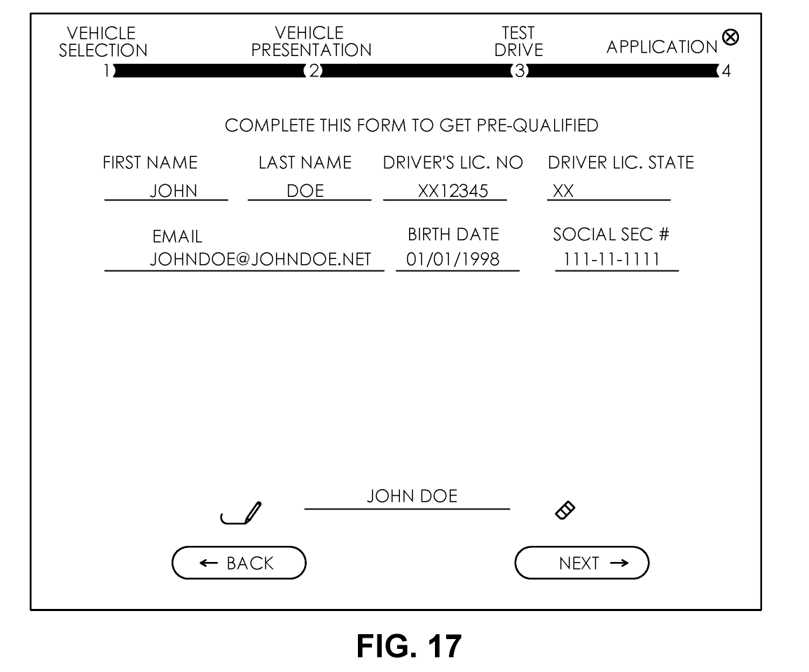

In an alternative embodiment, various other interactive user interfaces can be displayed to the user to obtain additional data relating to the user such that a pre-qualification for a loan can be processed. For example, FIG. 17 illustrates an additional interactive user interface that can be displayed to a user to obtain additional user data such that a pre-qualification can be processed. A retail support method 400 for purchasing an item is described in more detail with respect to FIGS. 18 and 19, described below, and can be completed in combination with method 100, method 300, method 600, or separate from method 100, method 300, or method 600.

While method 300 has been described as being accomplished with respect to a vehicle, method 300 can be accomplished with respect to any suitable item, such as those described herein. While various steps, alternative steps, and optional steps have been described above with respect to method 300, these steps, alternative steps, and optional steps can be included in, accomplished concurrently with, and/or accomplished in the alternative to, the other methods, steps, alternative steps, and/or optional steps described herein, such as those included in method 100, method 400, and/or method 600.

FIGS. 18 and 19 are schematic illustrations of another retail support method 400.

A step 402 comprises providing a first interactive user interface that displays an image of a vehicle, class identifiers associated with the vehicle, attributes associated with the vehicle, and provides a first user interface element to request additional information relating to purchasing the vehicle. Another step 404 comprises receiving data relating to a request from a user for additional information relating to purchasing the vehicle. Another step 406 comprises providing a second interactive user interface that requests data relating to a user and provides a second user interface element to submit the data to a retail support system. Another step 408 comprises receiving the data relating to the user. Another step 410 comprises submitting the data relating to the user to one or more external sources for review. Another step 412 comprises receiving data from the one or more external sources relating to a review by the one or more external sources of the data relating to the user. Another step 414 comprises providing a third interactive user interface that displays one or more purchase options and provides a third user interface element for selecting one of the one or more purchase options. Another step 416 comprises receiving data relating to a selected purchase option. Another step 418 comprises providing a fourth interactive user interface that requests additional data relating to the user and provides a fourth user interface element to submit the additional data to the retail support system. Another step 420 comprises receiving the additional data relating to the user. Another step 422 comprises providing a fifth interactive user interface that request data relating to a trade-in and provides a fifth user interface element to submit the data to the retail support system. Another step 424 comprises receiving the data relating to the trade-in. Another step 426 comprises providing a sixth interactive user interface that displays data relating to a trade-in value and provides a sixth user interface element for selecting use of the trade-in value against a purchase price of the vehicle. Another step 428 comprises receiving data relating to a selection of use of the trade-in value against the purchase price of a vehicle. Another step 430 comprises providing a seventh interactive user interface that displays data relating to a discount associated with the vehicle and provides a seventh user interface element for selecting a discount. Another step 432 comprises receiving data relating to the discounts. Another step 434 comprises providing an eighth interactive user interface that displays data relating to one or more discounts that apply to the vehicle and provides an eighth user interface element for continuing the method. Another step 436 comprises receiving the data relating to the continuation of the method. Another step 438 comprises providing a ninth interactive user interface that displays data relating to one or more protection plans that can be applied to the sale of the vehicle and provides a ninth user interface element for selecting one of the protection plans. Another step 440 comprises receiving data relating to whether a protection plan has been selected. Another step 442 comprises providing a tenth interactive user interface that displays data relating to one or more options for delivering the vehicle and provides a tenth user interface element for selecting one or more of the options for delivering the vehicle. Another step 444 comprises receiving data relating to delivery of the vehicle. Another step 446 comprises providing an eleventh interactive user interface that displays data relating to delivery of the vehicle.

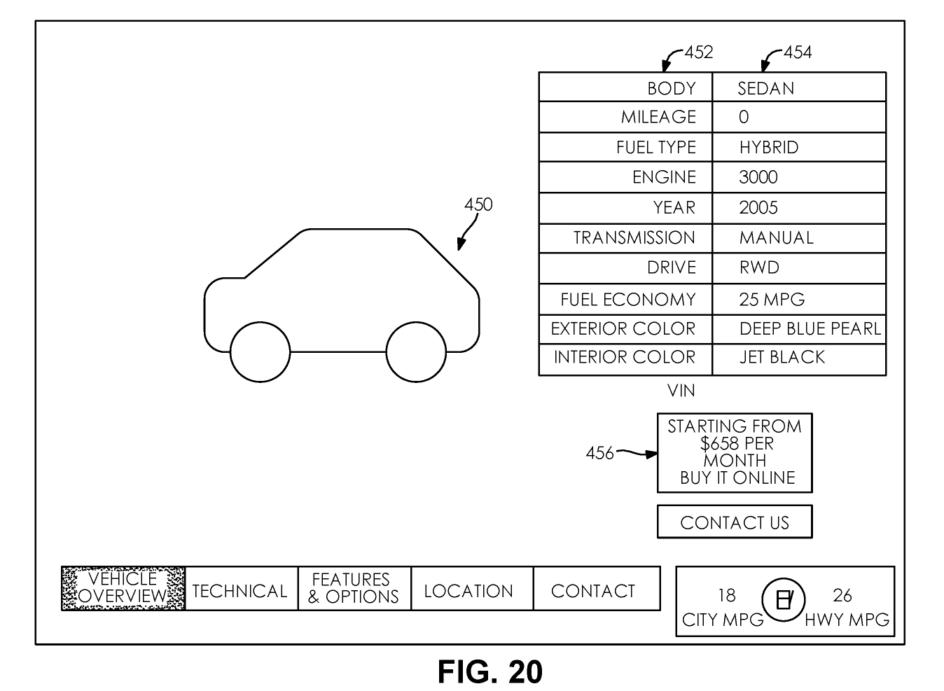

Step 402 can be accomplished using any suitable technique or method of providing an interactive user interface, such as those described herein. FIG. 20 illustrates an example first interactive user interface that displays an image of a vehicle 450, class identifiers 452 associated with the vehicle 450, and attributes 454 associated with the vehicle 450. As shown in FIG. 20, the user interface element for requesting additional information relating to the purchasing the vehicle includes an electronic button 456. Step 402 can be accomplished by obtaining an image, class identifiers, and attributes associated with a vehicle using any suitable technique or method. For example, an image, class identifiers, and/or attributes associated with a vehicle can be obtained by the retail support system 202 pulling data from one or more, or each, of the database 224 and/or the external sources, such as the user devices 206, the vehicle fill server 208, the credit bureau source 210, the notification system 212, the lender network 214, the customer relationship management system 216, the insurance provider source 218, the trade-in system 220, and/or the pricing server 222 in real-time or from database 224.

Step 404 can be accomplished using any suitable technique or method of receiving data relating to a request for additional information relating to purchasing the vehicle, such as those described herein. For example, once a user utilizes a user interface element for requesting additional information relating to purchasing the vehicle, such as by clicking on the electronic button 456 provided on user device 206, data is pushed to, or pulled by, the retail support system 202 from the user device 206 such that the data is received by the retail support system 202.

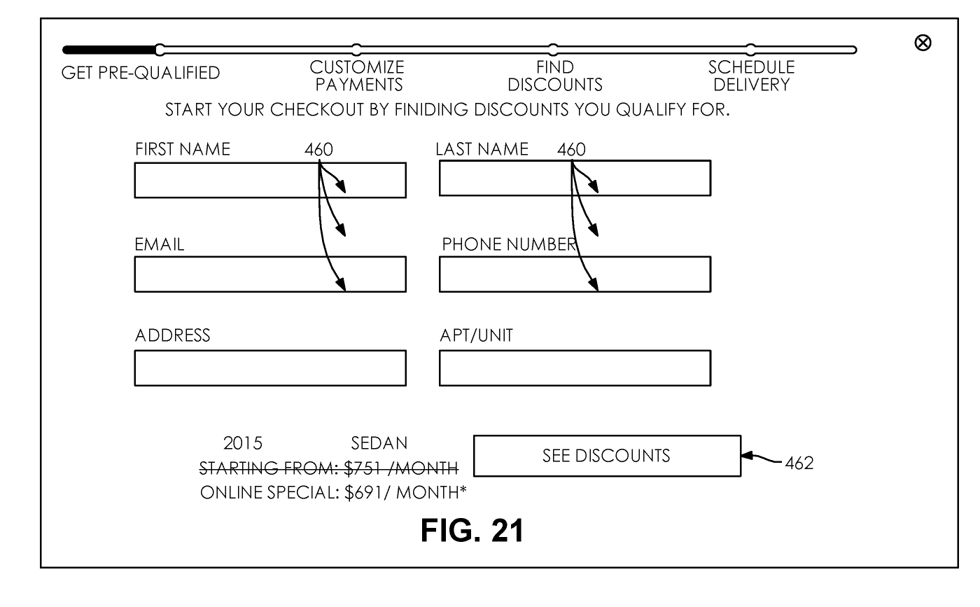

Step 406 can be accomplished using any suitable technique or method of providing an interactive user, such as those described herein. FIG. 21 illustrates a second interactive user interface that displays one or more fields 460 that request information relating to a user. As shown in FIG. 21, the user interface element to submit the information to a retail support system includes an electronic button 462.

Step 408 can be accomplished using any suitable technique or method of receiving the data relating to the user, such as those described herein. For example, once a user utilizes a user interface element for submitting the information to a retail support system, such as by entering data in the one or more of the fields 460 and clicking on the electronic button 462, data is pushed to, or pulled by, the retail support system 202 from the user device 206 such that the data is received by the retail support system 202.

Step 410 can be accomplished using any suitable technique or method of submitting the data relating to the user to one or more external sources for review, such as those described herein. For example, once data is sent from the user device 206 to the retail support system 202 relating to the user, the retail support system 202 can push the data to one or more of the external sources, such as the credit bureau source 210 and/or the lender network 214.

Step 412 can be accomplished using any suitable technique or method of receiving data from the one or more external sources relating to a review by the one or more external sources of the data relating to the user, such as those described herein. For example, once an external source has reviewed the data relating to the user, data is pushed to, or pulled by, the retail support system 202 from the one or more external sources such that the data is received by the retail support system 202. The data received from a credit bureau source, for example, can be used to determine available loan options for a user desiring to purchase an item based on the item intended on being purchased. For example, if a user has a high credit score, the may be able to purchase a more expensive care at a lower interest rate.

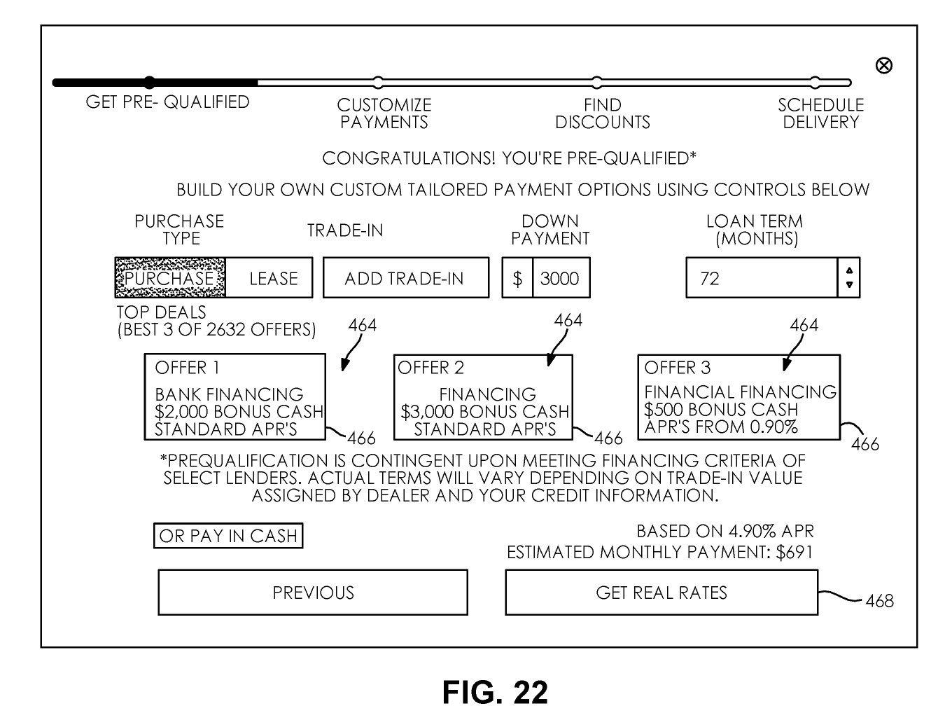

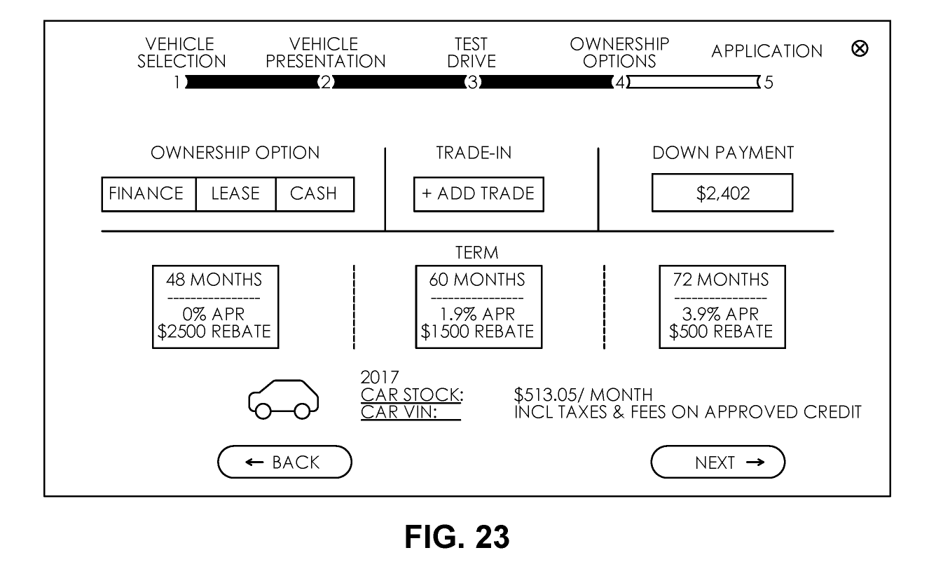

Step 414 can be accomplished using any suitable technique or method of providing an interactive user interface, such as those described herein. FIG. 22 illustrates an example third interactive user interface that displays one or more purchase options 464. As shown in FIG. 22, the user interface element for selecting one of the one or more purchase options includes a selectable icon 466. An alternative screen shot of an example user interface that can be utilized with respect to step 414 is illustrated in FIG. 23.

Step 416 can be accomplished using any suitable technique or method of receiving data relating to a selected purchase option, such as those described herein. For example, once a user utilizes a user interface element selecting one of the one or more purchase options, such as clicking on a selectable icon 466 provided on user device 206 and submits the selection (e.g., by pressing user interface element 468, as shown in FIG. 22) to the retail support system 202, data is pushed to, or pulled by, the retail support system 202 from the user device 206 such that the data is received by the retail support system 202.

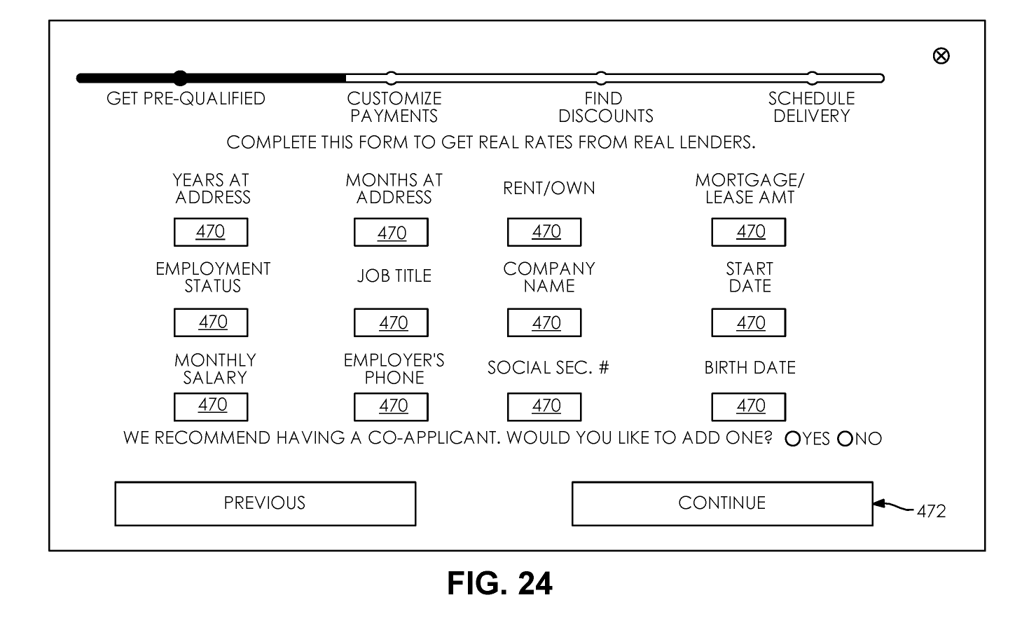

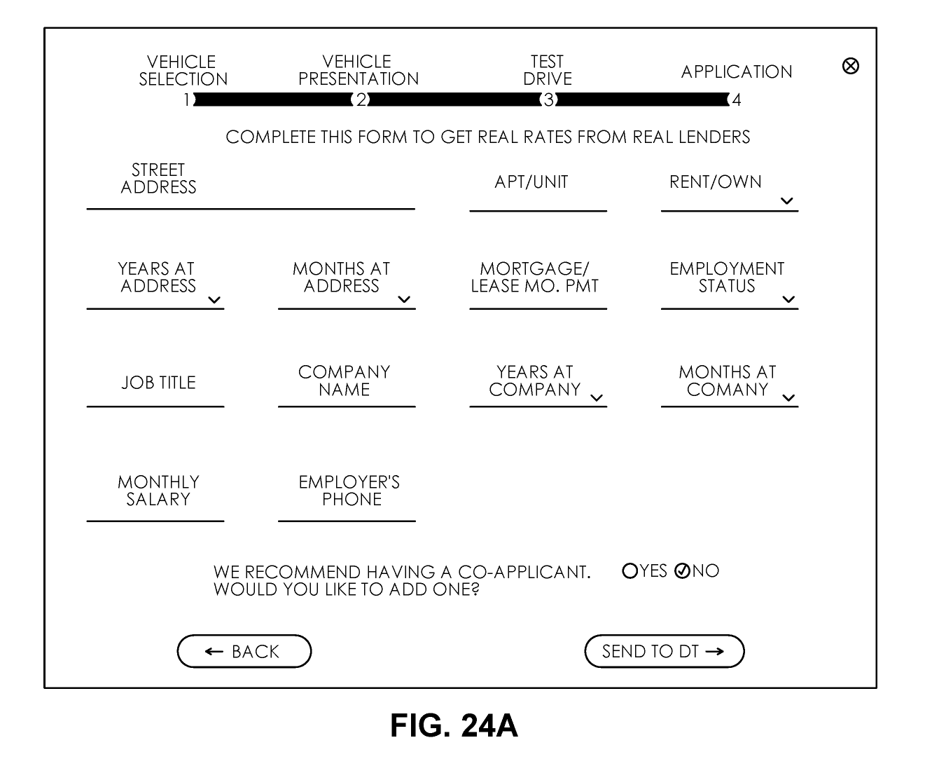

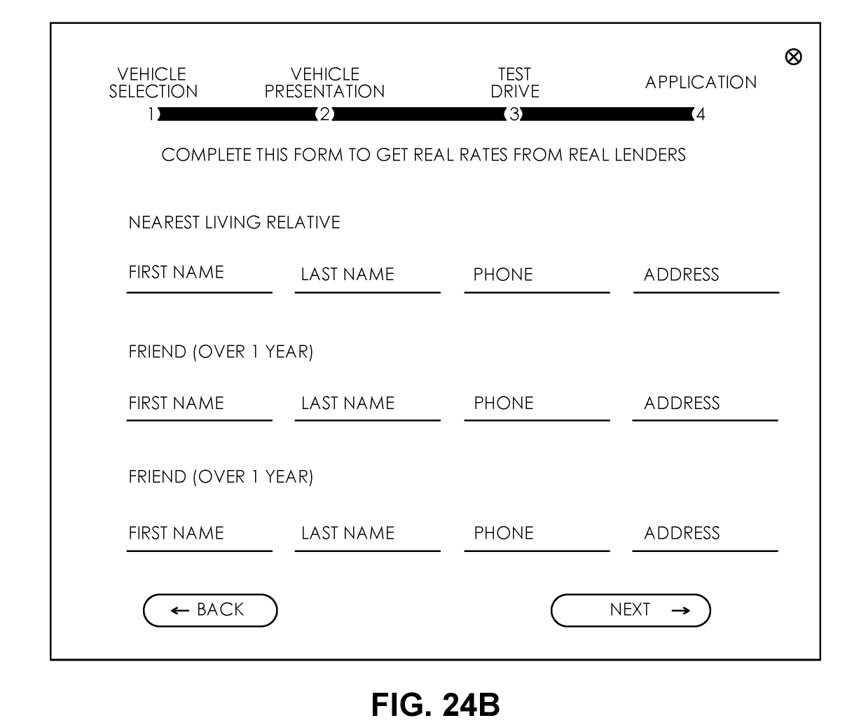

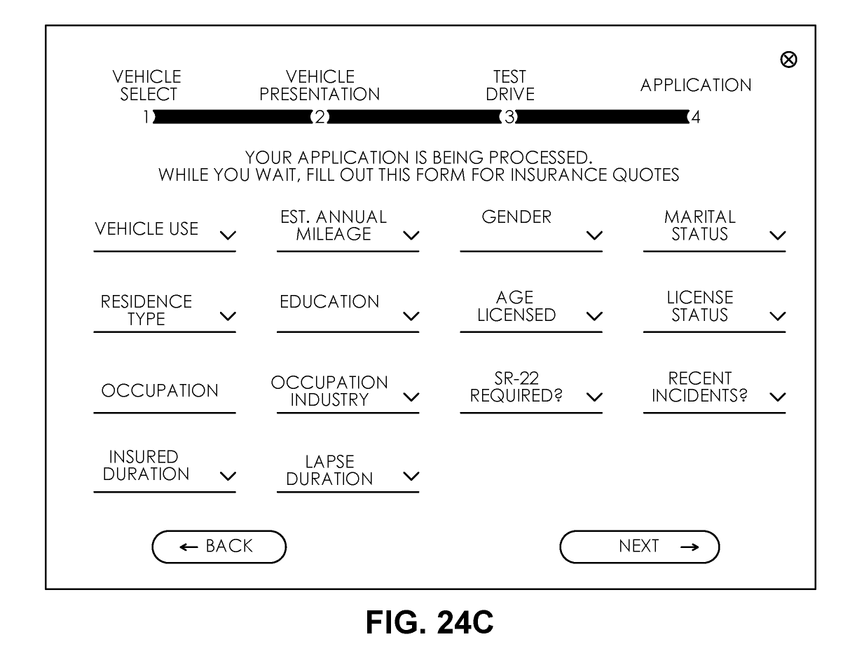

Step 418 can be accomplished using any suitable technique or method of providing an interactive user interface, such as those described herein. FIG. 24 illustrates an example fourth interactive user interface that displays one or more fields 470 that request additional data relating to the user. As shown in FIG. 24, the user interface element to submit the additional data to a retail support system includes an electronic button 472. Screen shots of other example user interfaces that can be utilized in combination with, or alternative to, the interactive user interface illustrated in FIG. 24 are illustrated in FIGS. 24A through 24C. The data obtained from a user using the one or more user interfaces shown in FIG. 24 or 24A through 24C can be sent to one or more external sources (e.g., dealer finance system, lending network) such that loan details can be provided to a user intending to purchase an item.

Step 420 can be accomplished using any suitable technique or method of receiving the additional data relating to the user, such as those described herein. For example, once a user utilizes a user interface element for submitting the additional data to a retail support system, such as by entering data in one or more of the fields 470 and clicking on the electronic button 472, data is pushed to, or pulled by, the retail support system 202 from the user device 206 such that the data is received by the retail support system 202. Once the data is received by the retail support system 202, the data is pushed to one or more external sources (e.g., credit bureaus source, lender network) such that the user's credit can be pushed to, or pulled by, the retail support system 202 from the external source. Optionally, once received, the user's credit can be saved within database 224 and/or sent to a user using notification system 212 (e.g., via email, text message).

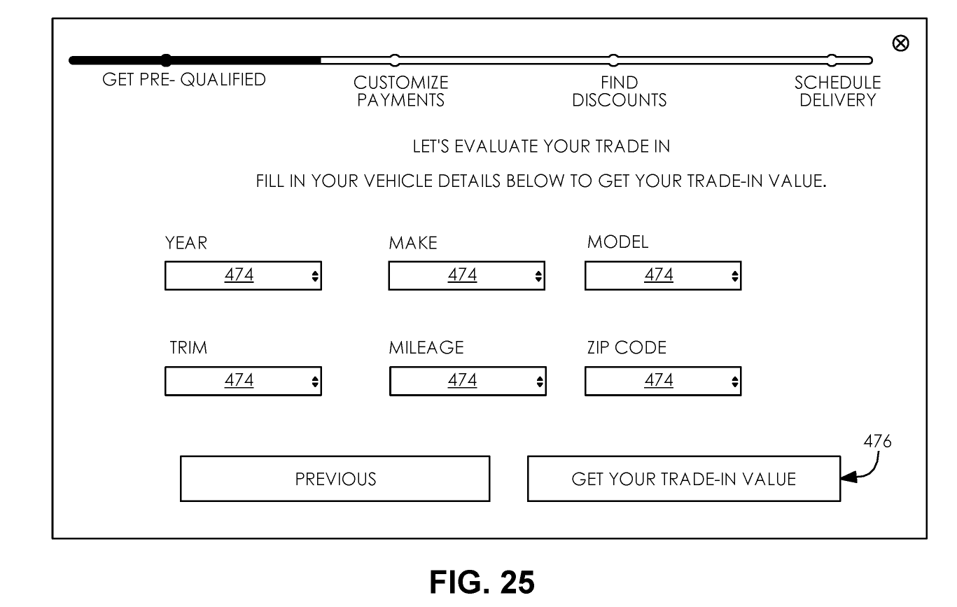

Step 422 can be accomplished using any suitable technique or method of providing an interactive user interface, such as those described herein. FIG. 25 illustrates an example fifth interactive user interface that displays one or more fields 474 that request data relating to a trade-in. As shown in FIG. 25, the user interface element for submitting the data to a retail support system includes an electronic button 476.

Step 424 can be accomplished using any suitable technique or method of receiving the data relating to the trade-in, such as those described herein. For example, once a user utilizes a user interface element for submitting the data to a retail support system, such as by entering data in the one or more fields 474 and clicking on the electronic button 476, data is pushed to, or pulled by, the retail support system 202 from the user device 206 such that the data is received by the retail support system 202.

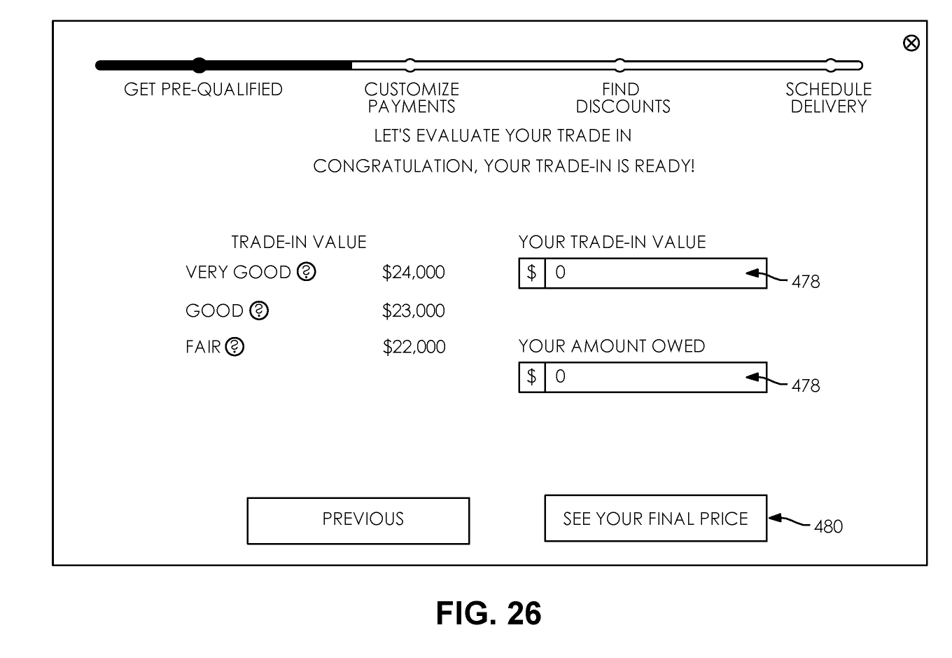

Step 426 can be accomplished using any suitable technique or method of providing an interactive user interface, such as those described herein. FIG. 26 illustrates an example sixth interactive user interface that displays data relating to a trade-in value associated with the trade-in 478. As shown in FIG. 26, the user interface element for selecting use of the trade-in value against a purchase price of the vehicle includes an electronic button 480.

Step 428 can be accomplished using any suitable technique or method of receiving data relating to a selection of use of the trade-in value against a purchase price of the vehicle, such as those described herein. For example, once a user utilizes a user interface element for selecting use of the trade-in value against a purchase price of the vehicle, such as clicking electronic button 480, data is pushed to, or pulled by, the retail support system 202 from the user device 206 such that the data is received by the retail support system 202.

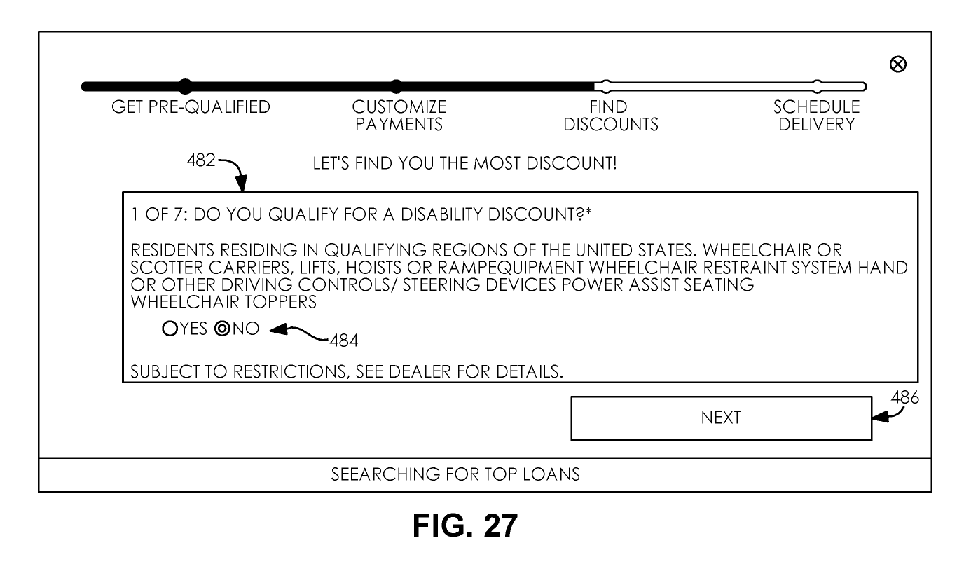

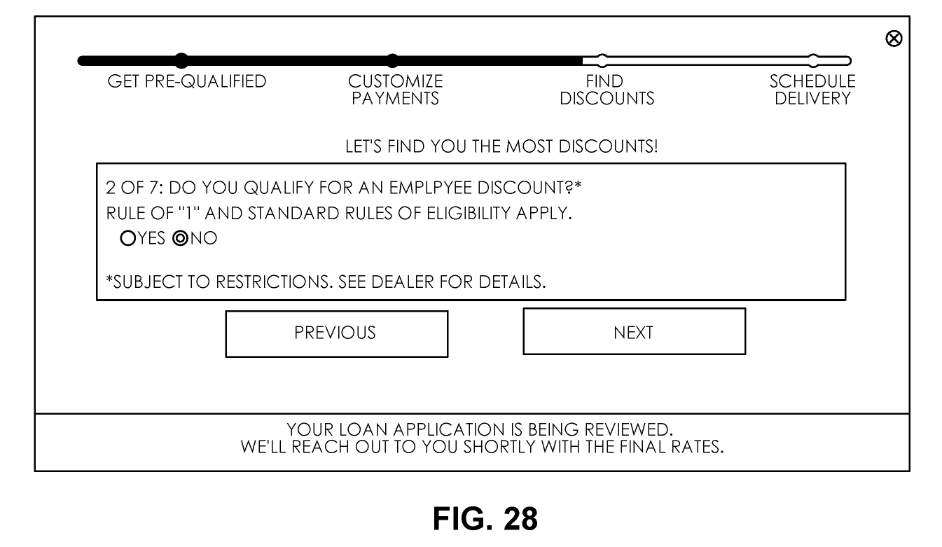

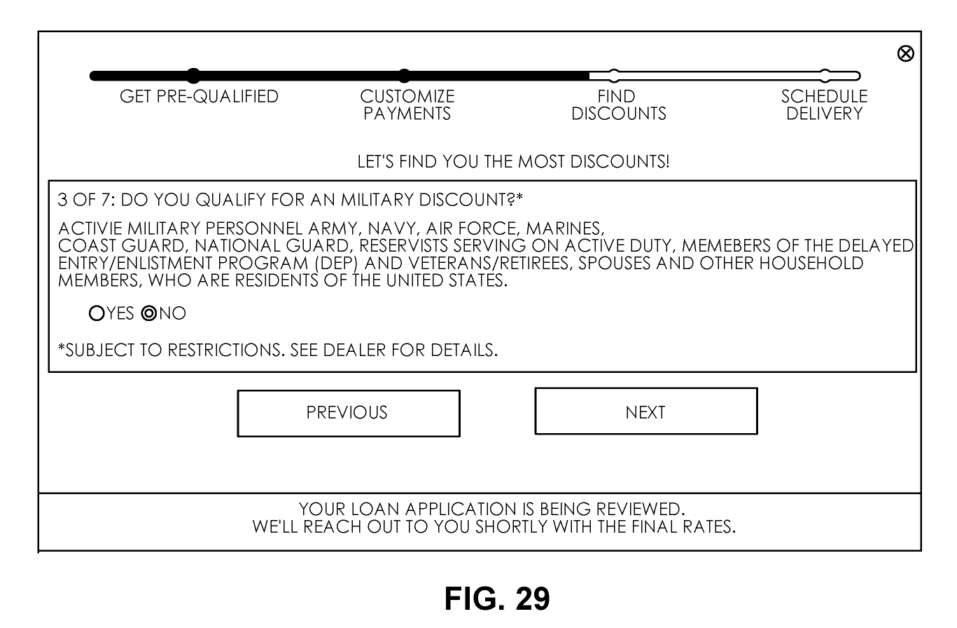

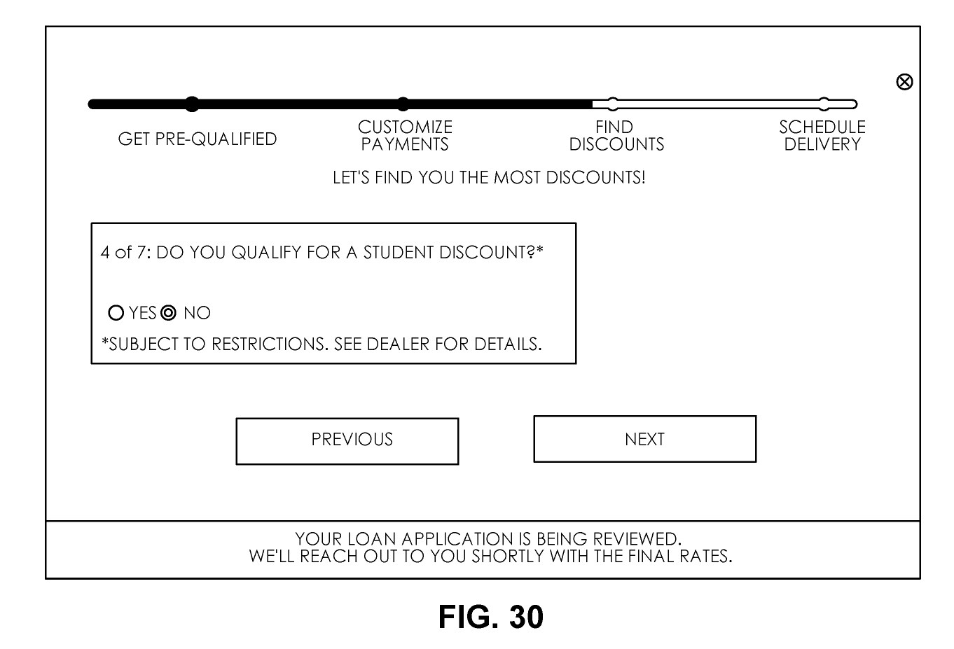

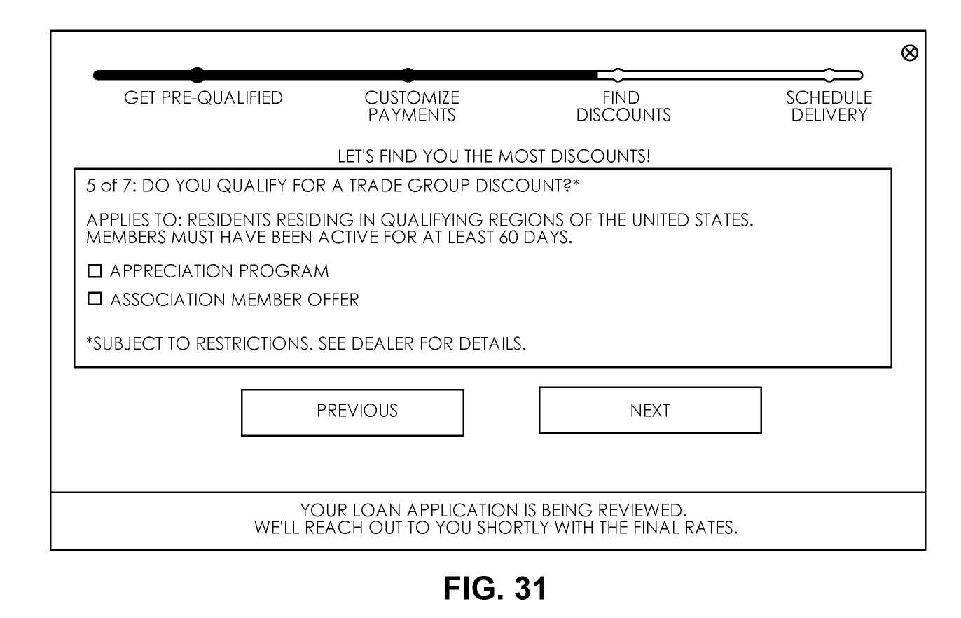

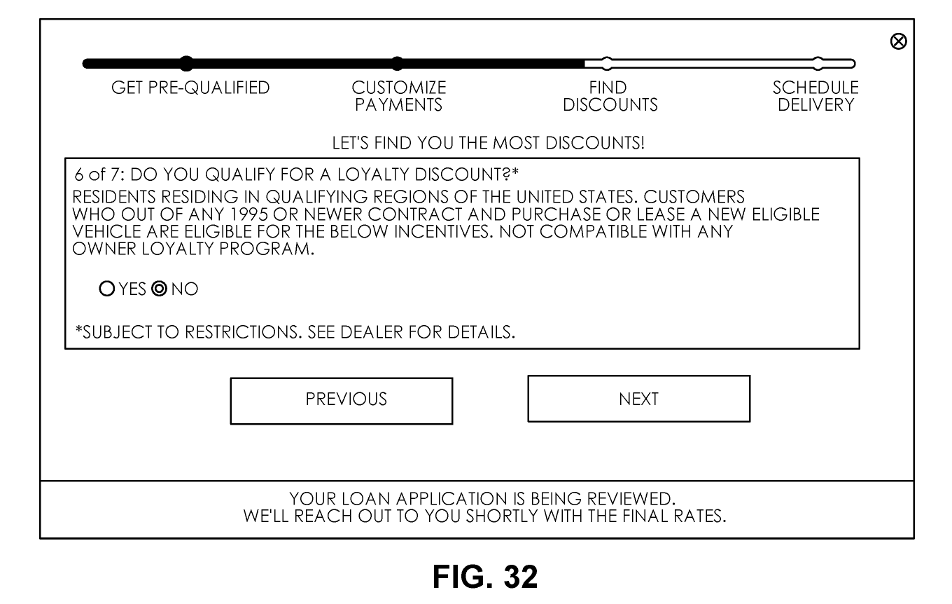

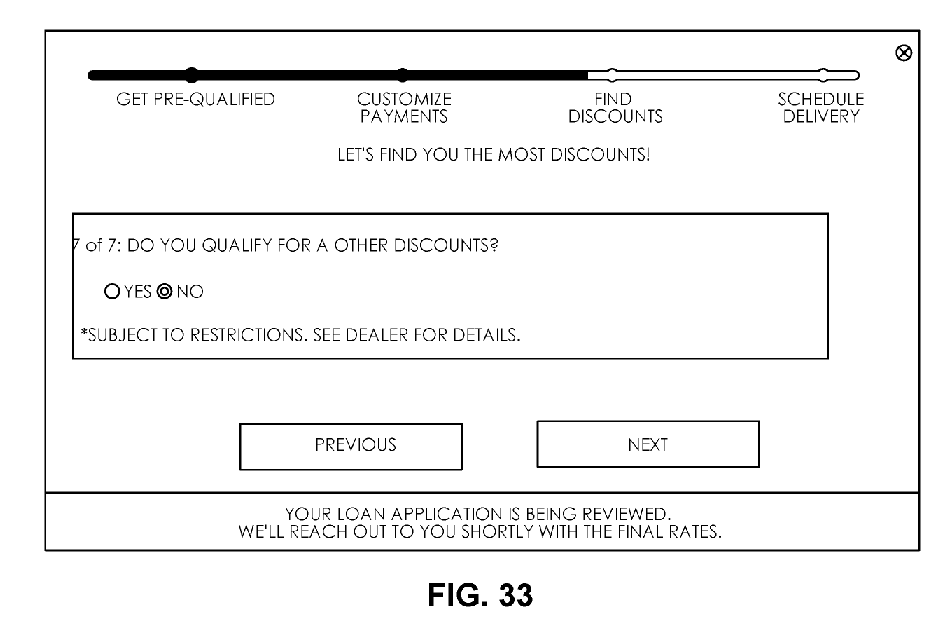

Step 430 can be accomplished using any suitable technique or method of providing an interactive user interface to a user, such as those described herein. FIG. 27 illustrates an example seventh interactive user interface that displays data relating to a discount associated with the vehicle 482. As shown in FIG. 27, the user interface element for selecting a discount option includes electronic buttons 484. Alternative embodiments can include additional steps for displaying a plurality of user interfaces that each provides data relating to a discount associated with the vehicle and provides a user interface element for selecting discount options and submitting the information to the retail support system and steps for receiving data relating to the discount options. Screen shots of other example user interfaces that can be utilized in combination with, or alternative to, the interactive user interface illustrated in FIG. 27 are illustrated in FIGS. 28 through 33. Step 430 can be accomplished by obtaining data using any suitable technique or method. For example, data associated with a discount can be obtained by the retail support system 202 pulling data from one or more, or each, of the database 224 and/or the external sources, such as the user devices 206, the vehicle fill server 208, the credit bureau source 210, the notification system 212, the lender network 214, the customer relationship management system 216, the insurance provider source 218, the trade-in system 220, and/or the pricing server 222 in real-time or from database 224 or another database. The data obtained by the retail support system 202 can be included in one or more of the user interfaces described herein.

Step 432 can be accomplished using any suitable technique or method of receiving data relating to the discount options, such as those described herein. For example, once a user utilizes a user interface element for selecting discount options, such as clicking electronic buttons 484 provided on the user device 206 and submits the selection (e.g., by pressing the next electronic button 486, as shown in FIG. 27) to the retail support system 202, data is pushed to, or pulled by, the retail support system 202 from the user device 206 such that the data is received by the retail support system 202.

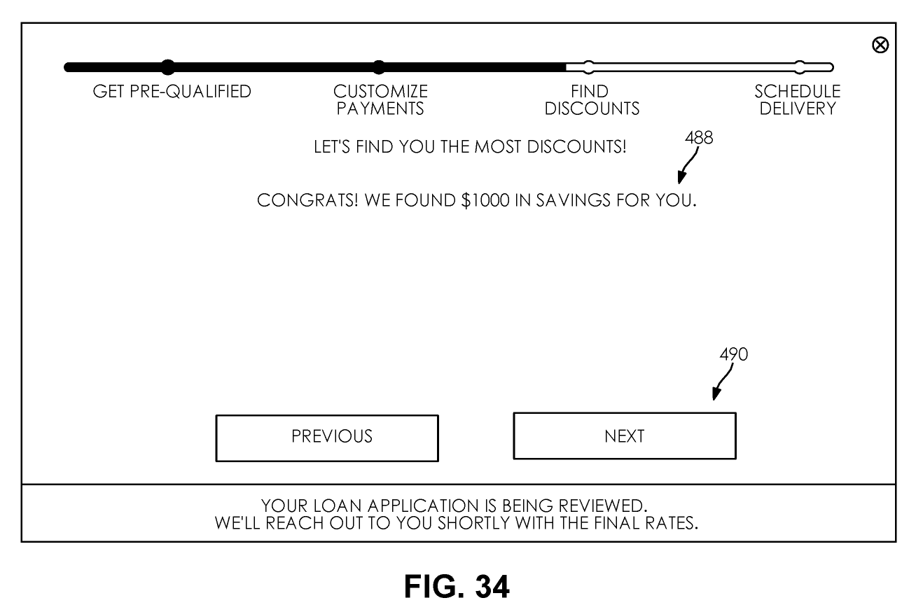

Step 434 can be accomplished using any suitable technique or method of providing an interactive user interface to a user, such as those described herein. FIG. 34 illustrates an example eighth interactive user interface that displays data relating to one or more discounts that apply to the vehicle 488. As shown in FIG. 34, the user interface element for selecting use of the discounts with respect to the purchase of the vehicle includes an electronic button 490.

Step 436 can be accomplished using any suitable technique or method of receiving the information relating to the continuation of the method, such as those described herein. For example, once a user utilizes a user interface element for continuing with the method, such as clicking electronic buttons 490, data is pushed to, or pulled by, the retail support system 202 from the user device 206 such that the data is received by the retail support system 202.

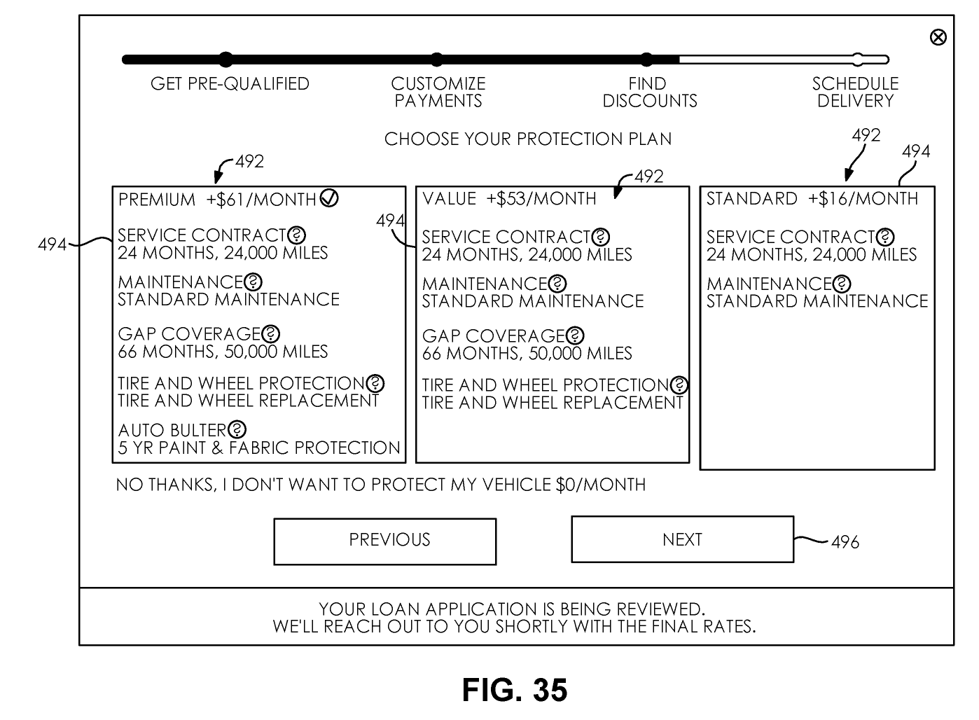

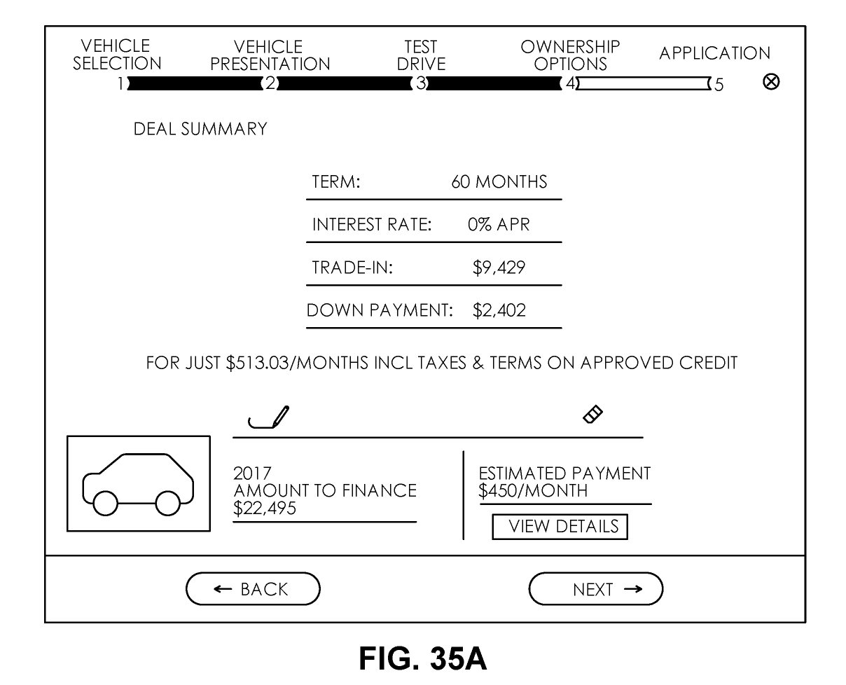

Step 438 can be accomplished using any suitable technique or method of providing an interactive user interface to a user, such as those described herein. FIG. 35 illustrates an example ninth interactive user interface that displays data relating to one or more protection plans that can be added to the sale of the vehicle 492. As shown in FIG. 35, the user interface element for selecting one of the protection plans includes a plurality of electronic buttons 494. FIG. 35A illustrates an example user interface that displays data relating to final details of a purchase and a field for providing a signature to agree to the purchase terms.

Step 440 can be accomplished using any suitable technique or method of receiving information relating to whether a protection plan has been selected, such as those described herein. For example, once a user utilizes a user interface element selecting one of the one or more protection plans, such as clicking on an electronic button 494 provided on user device 206 and submits the selection (e.g., by pressing the continue electronic button 496, as shown in FIG. 35) to the retail support system 202, data is pushed to, or pulled by, the retail support system 202 from the user device 206 such that the data is received by the retail support system 202.

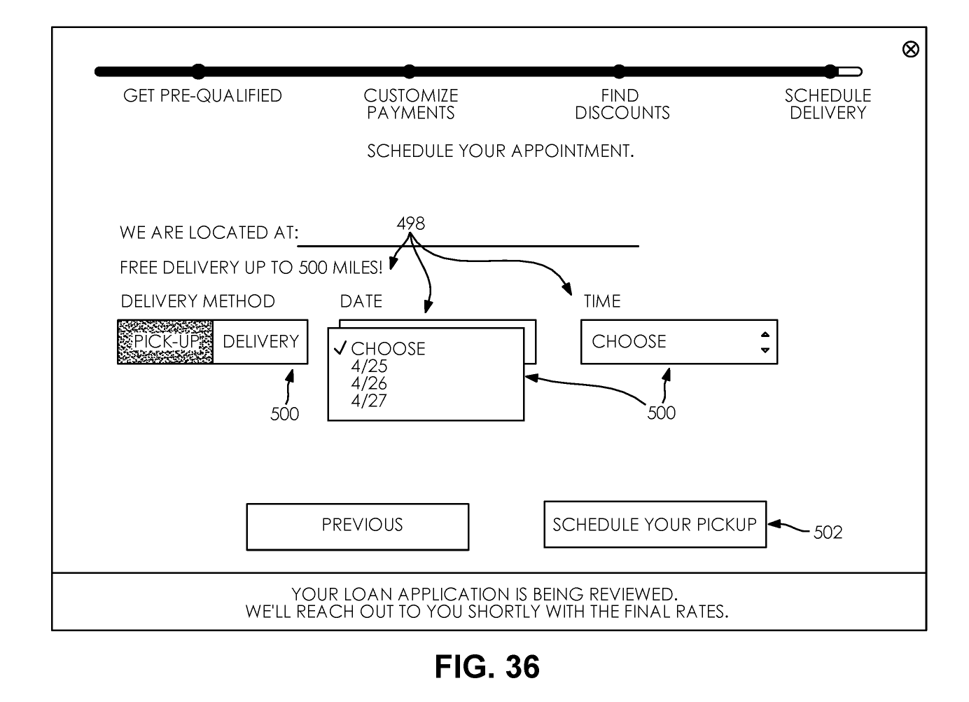

Step 442 can be accomplished using any suitable technique or method of providing an interactive user interface to a user, such as those described herein. FIG. 36 illustrates an example tenth interactive user interface that displays data relating to one or more options for delivering the vehicle 498. As shown in FIG. 34, the user interface element for selecting one or more of the options for delivering the vehicle includes a plurality of selectable fields 500.

Step 444 can be accomplished using any suitable technique or method of receiving information relating to delivery of the vehicle, such as those described herein. For example, once a user utilizes a user interface element for selecting one or more of the options for delivering the vehicle, such as selecting one or more selectable fields 500 provided on user device 206 and submits the selection (e.g., by pressing the schedule your pickup button 502, as shown in FIG. 36) to the retail support system 202, data is pushed to, or pulled by, the retail support system 202 from the user device 206 such that the data is received by the retail support system 202.

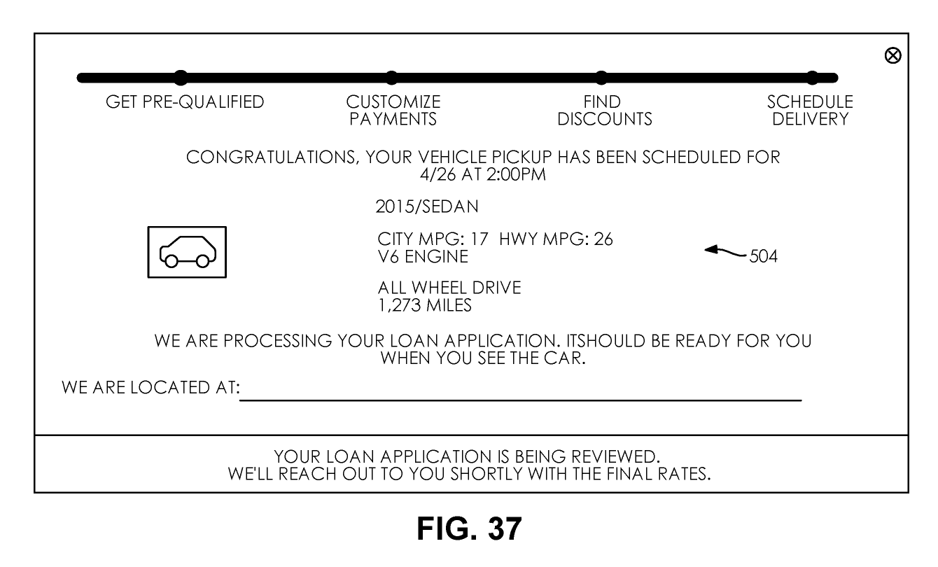

Step 446 can be accomplished using any suitable technique or method of providing an interactive user interface to a user, such as those described herein. FIG. 37 illustrates an example eleventh interactive user interface that displays data relating to delivery of the vehicle 504.

Optional steps that can be included in one or more of the methods of providing retail support described herein, such as method 100, method 300, method 400, and/or method 600 include the following steps. A first optional step comprises receiving additional data relating to the user such that one or more loan rates from one or more lenders can be obtained. This optional step can be accomplished by providing a user interface to a user that includes one or more fields for obtaining personal information from the user. Another optional step comprises pushing the data relating to the user and attributes associated with a selected item to the one or more lenders. This optional step can be accomplished by pushing data to one or more external sources, such as the user devices 206, the vehicle fill server 208, the credit bureau source 210, the notification system 212, the lender network 214, the customer relationship management system 216, the insurance provider source 218, the trade-in system 220, and/or the pricing server 222 in real-time or from database 224. Another optional step comprises receiving one or more loan rates from the one or more lenders based on the data received from the user and the selected item. This optional step can be accomplished by pulling data from one or more, or each, of the database 224 and/or the external sources, such as the user devices 206, the vehicle fill server 208, the credit bureau source 210, the notification system 212, the lender network 214, the customer relationship management system 216, the insurance provider source 218, the trade-in system 220, and/or the pricing server 222 in real-time or from database 224. The data obtained by the retail support system 202 can be included in one or more of the user interfaces described herein. Another optional step comprises providing a user interface that displays the one or more loan rates from the one or more lenders and provides a user interface element for selecting one or more of the loan rates. This optional step can be accomplished by providing a user interface to a user, as described herein. Another optional step comprises receiving data relating to a selection of the one or more loan rates.

Further optional steps that can be included in one or more of the methods of providing retails support described herein, such as method 100, method 300, method 400, and/or method 600, include the following steps. A first optional step comprises receiving additional data relating to the user such that one or more insurance rates from one or more insurance carriers can be obtained. This optional step can be accomplished by providing a user interface to a user that includes one or more fields for obtaining personal information from the user. Another optional step comprises pushing the data relating to the user and attributes associated with a selected item to the one or more insurance carriers. This optional step can be accomplished by pushing data to one or more external sources, such as the user devices 206, the vehicle fill server 208, the credit bureau source 210, the notification system 212, the lender network 214, the customer relationship management system 216, the insurance provider source 218, the trade-in system 220, and/or the pricing server 222 in real-time or from database 224. Another optional step comprises receiving one or more insurance rates from the one or more insurance carriers based on the data received from the user and the selected item. This optional step can be accomplished by pulling data from one or more, or each, of the database 224 and/or the external sources, such as the user devices 206, the vehicle fill server 208, the credit bureau source 210, the notification system 212, the lender network 214, the customer relationship management system 216, the insurance provider source 218, the trade-in system 220, and/or the pricing server 222 in real-time or from database 224. The data obtained by the retail support system 202 can be included in one or more of the user interfaces described herein. For example, retail support system 202 can be in communication with an API of insurance provider source 218 that can push data to, or allow data to be pulled by, in real-time, retail support system 202. Another optional step comprises providing a user interface that displays the one or more insurance rates from the one or more insurance carriers and provides a user interface element for selecting one or more of the insurance rates. This optional step can be accomplished by providing a user interface to a user, as described herein. Another optional step comprises receiving data relating to a selection of the one or more insurance rates. Another optional step comprises pushing the user to an insurance fulfillment platform that is operated by a third-party service to obtain insurance.

While method 400 has been described as being accomplished with respect to a vehicle, method 400 can be accomplished with respect to any suitable item, such as those described herein. While various steps, alternative steps, and optional steps have been described above with respect to method 400, these steps, alternative steps, and optional steps can be included in, accomplished concurrently with, and/or accomplished in the alternative to, the other methods, steps, alternative steps, and/or optional steps described herein, such as method 100, method 300, and/or method 600.

FIG. 38 is a schematic illustration of another retail support method 600.

A step 602 comprises obtaining data from one or more sources. Another step 604 comprises organizing the data into one or more data groups according to one or more rules. Another step 606 comprises providing a first interactive user interface that displays the data groups and provides a user interface element for selecting one or more data groups. Another step 608 comprises receiving data relating to a selection made by the user of one or more of the one or more data groups. Another step 610 comprises providing a second interactive user interface that displays the selected one or more data groups. This example retail support method provides a mechanism for a user to access data compiled by the retail support system 202 such that the user can understand the overall performance of another user (e.g., salesperson).

Step 602 can be accomplished by obtaining data using any suitable technique or method. For example, data can be obtained from one or more, or each, of the database 224 and/or the external sources, such as the user devices 206, the vehicle fill server 208, the credit bureau source 210, the notification system 212, the lender network 214, the customer relationship management system 216, the insurance provider source 218, the trade-in system 220, and/or the pricing server 222, in real-time or from database 224.

Step 604 can be accomplished by organizing the data such that each datum of the data is grouped within a data group. This step can be accomplished in real-time as an application is running the retail support method and/or completed before a retail support method is initiated. Data can be grouped into any suitable data group and selection of a suitable data group to group data can be based on various considerations, including the type of data being grouped. Examples of types of data groups include data groups that include data that relates to sales volume for a particular time period (e.g., day, month, year), total number of items sold, gross value of items sold, efficiency levels of a department which is based on one or more predefined parameters, number of customers greeted and/or checked into the system, potential issues with a pending sale, such as a customer being stuck on a particular user interface for a predetermine period of time (e.g., five minutes), customer unable to complete purchase based on various data (e.g., credit report data) and is test driving vehicle, number of customers that reach a specific step with a method described herein (e.g., request to test an item, apply for a loan), salesperson has requested third party assistance, the average credit score of walk-in customers, the average profit per sale, the average profit per sale by a salesperson, the average length of a test drive by a salesperson, the total number of customers greeted by each salesperson, and any other type of data group considered suitable for a particular embodiment. Each data group can be organized according to one or more rules or based on a predetermined time frame that is a default or selected by the user in step 606. Examples of time frames considered suitable to group a data group include one day, at least one day, a plurality of days, more than two days, thirty days, ninety days, and any other time frames considered suitable for a particular embodiment. Each data set can be gathered relative to a specific location selling one or more items (e.g., store) and/or relative to a specific region of locations selling one or more items (e.g., national, state, county).

Step 606 can be accomplished using any suitable technique or method of providing an interactive user interface, such as those described herein. An example user interface displays the data groups and provides a user interface element for selecting one or more data groups. Optionally, the data groups can be displayed to the user in real-time such that a live view of the data can be displayed to the user. For example, when a first user (e.g., manager) desires to view whether a second user (e.g., salesperson) is with a third user (e.g., customer), the status of the third user, such as the status of the third user's use of a retail support method, trade-in statuses, and/or credit report data, the first user can initiate method 600 and be presented with a first interactive user interface (e.g., dashboard) to view the data. Optionally, one or more of the data groups can be highlighted on the interactive user interface such that the manager can take appropriate action (e.g., potential issues with a sale).

Step 608 can be accomplished using any suitable technique or method of receiving the data relating to a selection of one or more of the one or more data groups, such as those described herein. For example, once a user utilizes a user interface element for selecting one or more data groups, such as selecting one or more selectable buttons provided on user device 206, data is pushed to, or pulled by, the retail support system 202 from the user device 206 such that the data is received by the retail support system 202.

Step 610 can be accomplished using any suitable technique or method of providing a second interactive user interface, such as those described herein, that displays the selected one or more data groups to the user.

While various steps, alternative steps, and optional steps have been described above with respect to method 600, these steps, alternative steps, and optional steps can be included in, accomplished concurrently with, and/or accomplished in the alternative to, the other methods, steps, alternative steps, and/or optional steps described herein, such as method 100, method 300, and/or method 400.

Those with ordinary skill in the art will appreciate that various modifications and alternatives for the described and illustrated embodiments can be developed in light of the overall teachings of the disclosure. Accordingly, the particular arrangements disclosed are intended to be illustrative only and not limiting as to the scope of the invention, which is to be given the full breadth of the appended claims and any and all equivalents thereof.

What is claimed is:

1. A retail support method, the method comprising the steps of:
obtaining one or more attributes associated with each item of a plurality of items, each attribute based on a specific quality of each item of the plurality of items;
organizing the one or more attributes such that one or more of the attributes of each item of the plurality of items is grouped within a class having a class identifier;
providing a first interactive user interface that displays to a user one or more of the class identifiers and provides a first user interface element for selecting one or more of the class identifiers;
receiving data relating to a selection made by the user of one or more of the one or more class identifiers;
providing a second interactive user interface that displays to the user one or more of the items based on the received data relating to the selection of one or more of the one or more class identifiers and provides a second user interface element for creating a selected subset comprising one or more items of the one or more of the items;
receiving data relating to the selected subset of the one or more items;
providing a third interactive user interface that displays to the user the selected subset of the one or more items, the attributes associated with the selected subset of the one or items, and provides a third user interface element for submitting a request to evaluate one or more items of the selected subset of the one or more items; and
making the one or more items of the selected subset of the one or more items available to the user for evaluation.

2. The method of claim 1, further comprising the step of receiving data relating to the request to evaluate one or more items of the selected subset of the one or more items; and
receiving additional data relating to the user based upon the receipt of data relating to the request to evaluate one or more items of the selected subset of the one or more items.

3. The method of claim 1, further comprising the step of providing a fourth user interface element to request assistance from a third party such that a notification is sent to a remote device controlled by the third party when data relating to a request for assistance from the third party is received.

4. The method of claim 3, further comprising the steps of:
receiving data relating to a request for assistance from the third party; and
sending the data relating to the request for assistance from the third party, data relating to the user, data relating to the selection made by the user of one or more of the one or more class identifiers, and data relating to the selected subset to the remote device controlled by the third party.

5. The method of claim 4, wherein the fourth user interface element to request assistance from a third party is a slide-bar that is not visible to the user.

6. The method of claim 1, wherein the item is a vehicle.

7. The method of claim 1, further comprising the steps of:
receiving additional data relating to the user such that one or more loan rates from one or more lenders can be obtained;
sending the data relating to the user and attributes associated with a selected item to the one or more lenders;
receiving one or more loan rates from the one or more lenders based on the data received from the user and the selected item;
providing a fourth user interface that displays to the user the one or more loan rates from the one or more lenders and provides a fourth user interface element for selecting one or more of the loan rates; and
receiving data relating to a selection made by the user of the one or more loan rates.

8. The method of claim 1, further comprising the steps of:
receiving additional data relating to the user such that one or more insurance rates from one or more insurance carriers can be obtained;
sending the data relating to the user and attributes associated with a selected item to the one or more insurance carriers;
receiving one or more insurance rates from the one or more insurance carriers based on the data received from the user and the selected item;
providing a fourth user interface that displays to the user the one or more insurance rates from the one or more insurance carriers and provides a fourth user interface element for selecting one or more of the insurance rates;
receiving data relating to a selection made by the user of the one or more insurance rates; and
pushing the user to an insurance fulfillment platform that is operated by a third-party service.

9. The method of claim 1, further comprising the steps of:
providing a fourth user interface element to request additional information relating to purchasing the item;
receiving data relating to a request for additional information relating to purchasing the item; and
providing a fourth interactive user interface that displays to the user one or more purchase options and provides a fifth user interface element for selecting one of the one or more purchase options.

10. A retail support method, the method comprising the steps of:
obtaining one or more attributes associated with each vehicle of a plurality of vehicles, each attribute based on a specific quality of each vehicle of the plurality of vehicles;
organizing the one or more attributes such that one or more of the attributes of each vehicle of the plurality of vehicles is grouped within a class having a class identifier;
providing a first interactive user interface that displays to a user one or more of the class identifiers and provides a first user interface element for selecting one or more of the class identifiers;
receiving data relating to a selection made by the user of one or more of the one or more class identifiers;
providing a second interactive user interface that displays to the user one or more of the vehicles based on the received data relating to the selection of one or more of the one or more class identifiers and provides a second user interface element for creating a selected subset comprising one or more vehicles of the one or more of the vehicles;
receiving data relating to the selected subset of the one or more vehicles;
providing a third interactive user interface that displays to the user the selected subset of the one or more vehicles, the attributes associated with the selected subset of the one or more vehicles, and provides a third user interface element for submitting a request to evaluate one or more vehicles of the selected subset of the one or more vehicles;
making the one or more vehicles of the selected subset of the one or more vehicles available to the user for evaluation; and
providing a fourth user interface element to request assistance from a third party such that a notification is sent to a remote device controlled by the third party when data relating to a request for assistance from the third party is received.

11. The method of claim 10, further comprising the step of receiving data relating to the request to evaluate one or more vehicles of the selected subset of the one or more vehicles; and
receiving additional data relating to the user based upon the receipt of data relating to the request to evaluate one or more vehicles of the selected subset of the one or more vehicles.

12. The method of claim 10, further comprising the steps of:
receiving data relating to a request for assistance from the third party; and
sending the data relating to the request for assistance from the third party, data relating to the user, data relating to the selection of one or more of the one or more class identifiers, and data relating to the selected subset to the remote device controlled by the third party.

13. The method of claim 12, wherein the fourth user interface element to request assistance from a third party is a slide-bar that is not visible to the user.

14. The method of claim 10, further comprising the steps of:
receiving additional data relating to the user such that one or more loan rates from one or more lenders can be obtained;
sending the data relating to the user and attributes associated with a selected vehicle to the one or more lenders;
receiving one or more loan rates from the one or more lenders based on the data received from the user and the selected vehicle;
providing a fifth user interface that displays to the user the one or more loan rates from the one or more lenders and provides a fifth user interface element for selecting one or more of the loan rates; and
receiving data relating to a selection made by the user of the one or more loan rates.

15. The method of claim 10, further comprising the steps of:
receiving additional data relating to the user such that one or more insurance rates from one or more insurance carriers can be obtained;
sending the data relating to the user and attributes associated with a selected vehicle to the one or more insurance carriers;
receiving one or more insurance rates from the one or more insurance carriers based on the data received from the user and the selected vehicle;
providing a fifth user interface that displays to the user the one or more insurance rates from the one or more insurance carriers and provides a fifth user interface element for selecting one or more of the insurance rates;
receiving data relating to a selection made by the user of the one or more insurance rates; and
pushing the user to an insurance fulfillment platform that is operated by a third-party service.

16. The method of claim 10, further comprising the steps of:
providing a fifth user interface element to request additional information relating to purchasing the vehicle;
receiving data relating to a request for additional information relating to purchasing the vehicle; and
providing a fifth interactive user interface that displays to the user one or more purchase options and provides a sixth user interface element for selecting one of the one or more purchase options.

17. A retail support method, the method comprising the steps of:
obtaining one or more attributes associated with each vehicle of a plurality of vehicles, each attribute based on a specific quality of each vehicle of the plurality of vehicles;
organizing the one or more attributes such that one or more of the attributes of each vehicle of the plurality of vehicles is grouped within a class having a class identifier;
providing a first interactive user interface that displays to the user one or more of the class identifiers and provides a first user interface element for selecting one or more of the class identifiers;
receiving data relating to a selection made by the user of one or more of the one or more class identifiers;
providing a second interactive user interface that displays to the user one or more of the vehicles based on the received data relating to the selection of one or more of the one or more class identifiers and provides a second user interface element for creating a selected subset comprising one or more vehicles of the one or more of the vehicles;
receiving data relating to the selected subset of the one or more vehicles;
providing a third interactive user interface that displays to the user the selected subset of the one or more vehicles, the attributes associated with the selected subset of the one or more vehicles, and provides a third user interface element submitting a request to evaluate one or more vehicles of the selected subset of the one or more vehicles;
making the one or more vehicles of the selected subset of the one or more vehicles available to the user for evaluation;
receiving data relating to the request to evaluate one or more vehicles of the selected subset of the one or more vehicles;
receiving additional data relating to the user based upon the receipt of data relating to the request to evaluate one or more vehicles of the selected subset of the one or more vehicles;
providing a fourth user interface element to request assistance from a third party such that a notification is sent to a remote device controlled by the third party when data relating to a request for assistance from the third party is received;
receiving data relating to a request for assistance from the third party; and
sending the data relating to the request for assistance from the third party, data relating to the user, data relating to the selection of one or more of the one or more class identifiers, and data relating to the selected subset to the remote device controlled by the third party.

18. The method of claim 17, wherein the fourth user interface element to request assistance from a third party is a slide-bar that is not visible to the user.

19. The method of claim 17, further comprising the steps of:
receiving additional data relating to the user such that one or more loan rates from one or more lenders can be obtained;
sending the data relating to the user and attributes associated with a selected vehicle to the one or more lenders;
receiving one or more loan rates from the one or more lenders based on the data received from the user and the selected vehicle;
providing a fifth user interface that displays to the user the one or more loan rates from the one or more lenders and provides a fifth user interface element for selecting one or more of the loan rates; and
receiving data relating to a selection made by the user of the one or more loan rates.

20. The method of claim 17, further comprising the steps of:
receiving additional data relating to the user such that one or more insurance rates from one or more insurance carriers can be obtained;
sending the data relating to the user and attributes associated with a selected vehicle to the one or more insurance carriers;
receiving one or more insurance rates from the one or more insurance carriers based on the data received from the user and the selected vehicle;
providing a fifth user interface that displays to the user the one or more insurance rates from the one or more insurance carriers and provides a fifth user interface element for selecting one or more of the insurance rates;
receiving data relating to a selection made by the user of the one or more insurance rates; and
pushing the user to an insurance fulfillment platform that is operated by a third-party service.
